(19) United States
(12) Patent Application Publication
(10) Pub. No.: US 2026/0278861 A1
(43) Pub. Date: Sep. 17, 2026

(54) VIDEO GENERATION METHOD AND APPARATUS, ELECTRONIC DEVICE, STORAGE MEDIUM, AND PROGRAM PRODUCT

(71) Applicant: TENCENT TECHNOLOGY (SHENZHEN) COMPANY LIMITED, Shenzhen (CN)

(72) Inventors: Yajing HE, Shenzhen (CN); Yue ZHANG, Shenzhen (CN); Chengfei CAI, Shenzhen (CN); Weijie KONG, Shenzhen (CN); Wenzhe ZHAO, Shenzhen (CN); Bo CUI, Shenzhen (CN); Jianbing WU, Shenzhen (CN); Qilong ZHANG, Shenzhen (CN); Hongfa WANG, Shenzhen (CN); Wei LIU, Shenzhen (CN); Canshuang ZHENG, Shenzhen (CN); Jie XIAO, Shenzhen (CN); Jianbing PENG, Shenzhen (CN); Jinzhe YANG, Shenzhen (CN); Lei QIN, Shenzhen (CN); Yijun LUO, Shenzhen (CN); Yanxiang LIU, Shenzhen (CN)

(73) Assignee: TENCENT TECHNOLOGY (SHENZHEN) COMPANY LIMITED, Shenzhen (CN)

(21) Appl. No.: 19/675,158

(22) Filed: May 12, 2026

Related U.S. Application Data
(63) Continuation of application No. PCT/CN2024/137383, filed on Dec. 6, 2024.

(30) Foreign Application Priority Data
Jan. 15, 2024 (CN) 202410058005.3

(51) Int. Cl. G06T 11/00; G06F 3/04842

(52) U.S. Cl. CPC G06T 11/00; G06F 3/04842; G06T 2200/24

(57) ABSTRACT

A video generation method includes displaying at least one video generation control on a video generation interface, the at least one video generation control being configured for generating videos of at least two video types, displaying, based on the at least one video generation control associated with a target video type among the at least two video types being in a selected state, a content input region corresponding to the target video type, displaying inputted target content based on a content input operation being performed in the content input region, and displaying, based on a video generation instruction, a first video of the target video type that is generated based on the inputted target content.

### CROSS-REFERENCE TO RELATED APPLICATIONS

The application is a continuation application of International Application No. PCT/CN2024/137383 filed on Dec. 6, 2024, which claims priority to Chinese Patent Application No. 202410058005.3 filed with the China National Intellectual Property Administration on Jan. 15, 2024, the disclosures of each being incorporated by reference herein in their entireties.

### FIELD

The disclosure relates to the field of Internet technologies, and in particular, to a video generation method and apparatus, an electronic device, a computer-readable storage medium, and a computer program product.

### BACKGROUND

There are many types of videos, for example, short videos and long videos. Different types of videos correspond to different video parameters and different video generation processes. However, in the related art, videos are mostly generated directly based on requirements of users for video content. That is, the requirements of the users for the video content are only considered, and requirements of the users for video types are ignored. In this way, the users further need to clip videos to generate final videos, so that the final videos meet the requirements of the users for the video types while meeting the requirements of the users for the video content. In this way, the video generation efficiency is low. Meanwhile, the human-computer interaction efficiency and the utilization rate of hardware processing resources are low.

### SUMMARY

The disclosure provides a video generation method and apparatus, an electronic device, a computer-readable storage medium, and a computer program product, which can enhance video generation efficiency, human-computer interaction efficiency, and a utilization rate of hardware processing resources.

One or more embodiments provides a video generation method, including: displaying at least one video generation control on a video generation interface, the at least one video generation control being configured for generating videos of at least two video types; displaying, based on the at least one video generation control associated with a target video type among the at least two video types being in a selected state, a content input region corresponding to the target video type; displaying inputted target content based on a content input operation being performed in the content input region; and displaying, based on a video generation instruction, a first video of the target video type that is generated based on the inputted target content.

One or more embodiments provides a video generation apparatus, including: at least one memory configured to store program code; and at least one processor configured to read the program code and operate as instructed by the program code, the program code comprising: first display code configured to cause at least one of the at least one processor to display at least one video generation control on a video generation interface, the at least one video generation control being configured for generating videos of at least two video types; second display code configured to cause at least one of the at least one processor to display, based on the at least one video generation control associated with a target video type among the at least two video types being in a selected state, a content input region corresponding to the target video type; third display code configured to cause at least one of the at least one processor to display inputted target content based on a content input operation performed in the content input region; and fourth display code configured to cause at least one of the at least one processor to display, based on a video generation instruction, a first video of the target video type that is generated based on the inputted target content.

One or more embodiments provides a non-transitory computer-readable storage medium, storing computer code which, when executed by at least one processor, causes the at least one processor to at least: display at least one video generation control on a video generation interface, the at least one video generation control being configured for generating videos of at least two video types; display, based on the at least one video generation control associated with a target video type among the at least two video types being in a selected state, a content input region corresponding to the target video type; display inputted target content based on a content input operation being performed in the content input region; and display, based on a video generation instruction, a first video of the target video type that is generated based on the inputted target content.

### BRIEF DESCRIPTION OF THE DRAWINGS

To describe the technical solutions of some embodiments of this disclosure more clearly, the following briefly introduces the accompanying drawings for describing some embodiments. The accompanying drawings in the following description show only some embodiments of the disclosure, and a person of ordinary skill in the art may still derive other drawings from these accompanying drawings without creative efforts. In addition, one of ordinary skill would understand that aspects of some embodiments may be combined together or implemented alone.

FIG. 1 is a schematic diagram of an architecture of a video generation system 100 according to one or more embodiments.

FIG. 2 is a schematic diagram of a structure of an electronic device according to one or more embodiments.

FIG. 3 is a schematic flowchart of a video generation method according to one or more embodiments.

FIG. 4A is a schematic diagram of displaying of a content input region according to one or more embodiments.

FIG. 4B is a schematic diagram of displaying of a content input region according to one or more embodiments.

FIG. 5 is a schematic diagram of guide information according to one or more embodiments.

FIG. 6A is a schematic diagram of a playback interface of another video according to one or more embodiments.

FIG. 6B is a schematic diagram of a playback interface of another video according to one or more embodiments.

FIG. 7 is a schematic diagram of permission prompt information according to one or more embodiments.

FIG. 8A is a schematic diagram of at least one video template according to one or more embodiments.

FIG. 8B is a schematic diagram of at least one video template according to one or more embodiments.

FIG. 8C is a schematic diagram of at least one video template according to one or more embodiments.

FIG. 9A is a schematic diagram of a details interface including detailed information of a target video template according to one or more embodiments.

FIG. 9B is a schematic diagram of a details interface including detailed information of a target video template according to one or more embodiments.

FIG. 10A is a schematic diagram of a first confirmation control according to one or more embodiments.

FIG. 10B is a schematic diagram of a first confirmation control according to one or more embodiments.

FIG. 10C is a schematic diagram of a first confirmation control according to one or more embodiments.

FIG. 10D is a schematic diagram of a first confirmation control according to one or more embodiments.

FIG. 11A is a schematic diagram of a display parameter setting region according to one or more embodiments.

FIG. 11B is a schematic diagram of a display parameter setting region according to one or more embodiments.

FIG. 12 is a schematic diagram of a storyboard breakdown interface according to one or more embodiments.

FIG. 13 is a schematic diagram of a storyboard generation interface according to one or more embodiments.

FIG. 14 is a schematic diagram of function introduction information according to one or more embodiments.

FIG. 15 is a schematic diagram of at least two candidate storyboards according to one or more embodiments.

FIG. 16 is a schematic diagram of a video display interface of a long video according to one or more embodiments.

FIG. 17 is a schematic diagram of a video display interface of a short video according to one or more embodiments.

FIG. 18 is a schematic diagram of first progress prompt information according to one or more embodiments.

FIG. 19 is a schematic diagram of second waiting prompt information according to one or more embodiments.

FIG. 20 is a schematic diagram of an asset video presentation interface according to one or more embodiments.

FIG. 21 is a schematic diagram of deletion prompt information according to one or more embodiments.

FIG. 22 is a schematic diagram of generation failure prompt information, a regeneration control, and a backtracking control according to one or more embodiments.

FIG. 23 is a schematic diagram of at least one video style according to one or more embodiments.

FIG. 24A is a schematic diagram of an identifier of a target video style according to one or more embodiments.

FIG. 24B is a schematic diagram of an identifier of a target video style according to one or more embodiments.

FIG. 25 is a schematic diagram of operation controls according to one or more embodiments.

FIG. 26A is a schematic diagram of interaction of a first video based on a local editing control according to one or more embodiments.

FIG. 26B is a schematic diagram of interaction of a first video based on a local editing control according to one or more embodiments.

FIG. 27 is a schematic diagram of performing interaction on a first video based on a canvas extension control according to one or more embodiments.

FIG. 28 is a schematic diagram of a structure of a video generation model according to one or more embodiments.

FIG. 29 is a schematic diagram of a sampling process according to one or more embodiments.

FIG. 30 is a schematic diagram of a processing process of a skeleton-guided dance video model according to one or more embodiments.

### DESCRIPTION OF EMBODIMENTS

To make the objectives, technical solutions, and advantages of the present disclosure clearer, the following further describes the present disclosure in detail with reference to the accompanying drawings. The described embodiments are not to be construed as a limitation to the present disclosure. All other embodiments obtained by a person of ordinary skill in the art without creative efforts shall fall within the protection scope of the present disclosure.

In the following descriptions, related “some embodiments” describe a subset of all possible embodiments. However, it may be understood that the “some embodiments” may be the same subset or different subsets of all the possible embodiments, and may be combined with each other without conflict. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. For example, the phrase “at least one of A, B, and C” includes within its scope “only A”, “only B”, “only C”, “A and B”, “B and C”, “A and C” and “all of A, B, and C.”.

The terms, involved in the following description, “first\second\third” are merely intended to distinguish similar objects rather than describing specific orders. “First\second\third” is interchangeable in proper circumstances to enable the embodiments of the disclosure to be implemented in other orders than those illustrated or described herein.

Unless otherwise defined, all technical and scientific terms used herein have the same meaning as those commonly understood by a person skilled in the art to which the present disclosure belongs. Terms used herein are merely intended to describe the embodiments of the disclosure, but are not intended to be limiting.

Before the embodiments of the disclosure are further described in detail, a description is made on nouns and terms in the embodiments of the disclosure, and the nouns and terms in the embodiments of the disclosure are applicable to the following explanations.
1) The expression “in response to” is configured for representing a condition or status on which one or more to-be-performed operations depend. When the condition or status is met, the one or more operations may be performed immediately or have a set delay. Unless otherwise specified, there is no chronological order between the plurality of to-be-performed operations.
(2) Client, also referred to as a user end, refers to a program corresponding to a server that provides a local service to a user. In addition to some applications that can only run locally, the client is generally installed on a terminal and needs to cooperate with the server to run. That is, the client requires a corresponding server and service program in a network to provide a corresponding service. In this way, a specific communication connection needs to be established on the client and a server side, to ensure a normal operation of an application, for example, a virtual scene client (such as a game client).
3) Storyboard is also referred to as a storyboard script, and is configured for instructing a series of images obtained by decomposing a script or a video in chronological order. Each image, that is, each storyboard, represents a shot, including a shot type, an angle, a motion, and the like of the shot.
4) Camera movement is also referred to as a moving shot, which is configured for indicating a photographing manner performed in a shot by moving a camera position, or changing an optical axis of a lens, or changing a focal length of the lens. An image captured in this photographing manner is referred to as a moving image, for example: dolly-in shots, dolly-out shots, pan shots, moving shots, tracking shots, crane shots, and comprehensive moving shots, which are formed by dolly-in, dolly-out, panning, moving, tracking, camera lifting and dropping, and comprehensive camera moving.

According to one or more embodiments, the at least one video generation control configured for generating the videos of the different video types is displayed. Then, the content input region corresponding to the target video type is displayed based on the at least one video generation control in response to the target video type among the at least two video types being in the selected state, and the target content is inputted based on the content input region, thus generating the first video of the target video type based on the inputted target content. In this way, the video of the target video type that corresponds to the target content is generated based on the target content inputted by a user, so that the content of the video of the target video type meets user requirements. Furthermore, the video of the target video type is generated based on the video generation control, so that the video type also meets the user requirements. Compared with a solution in which the user needs to clip a video to generate a final video, one or more embodiments of the disclosure reduces a clip operation needing to be performed by a user on a video, thereby not only enhancing video generation efficiency, but also enhancing human-computer interaction efficiency and increasing a utilization rate of hardware resources of an electronic device.

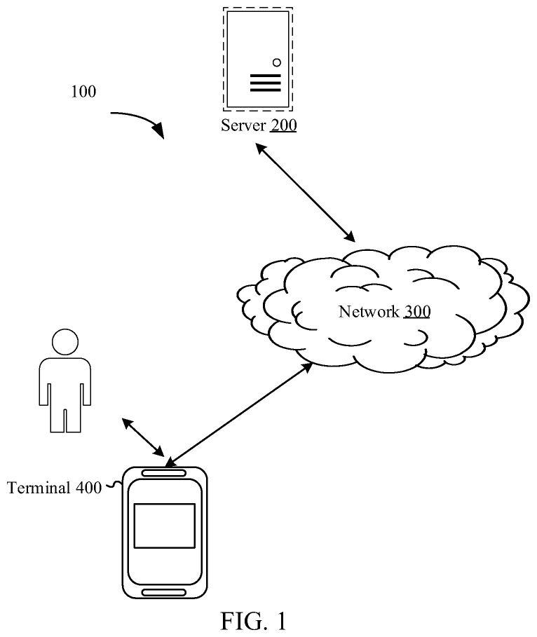

FIG. 1 is a schematic diagram of an architecture of a video generation system 100 provided by one or more embodiments. A terminal 400 (a terminal 400 is exemplarily shown) is connected to a server 200 through a network 300. The network 300 may be a wide area network or a local area network or a combination of a wide area network or the local area network, and implements data transmission by using a wireless or wired link.

The server 200 is configured to transmit, to the terminal 400, interface data corresponding to a video generation interface that includes at least one video generation control.

The terminal 400 is configured to: receive the interface data corresponding to the video generation interface that includes at least one video generation control; display a video generation interface based on the interface data; and display at least one video generation control on the video generation interface, the at least one video generation control being configured for generating videos of at least two video types; display, based on the at least one video generation control in response to a target video type among the at least two video types being in a selected state, a content input region corresponding to the target video type; display inputted target content in response to a content input operation performed in a content input region; and display, in response to a video generation instruction, a first video of the target video type that is generated based on the target content.

In some embodiments, the server 200 may be an independent physical server, or may be a server cluster formed by a plurality of physical servers or a distributed system, and may be further a cloud server providing basic cloud computing services such as a cloud service, a cloud database, cloud computing, a cloud function, cloud storage, a network service, cloud communication, a middleware service, a domain name service, a security service, a content delivery network (CDN), and a big data and artificial intelligence platform. The terminal 400 may be a smartphone, a tablet computer, a notebook computer, a desktop computer, a set-top box, an intelligent voice interaction device, a smart home appliance, a virtual reality device, an on-board terminal, an aircraft, a portable music player, a personal digital assistant, a dedicated messaging device, a portable game device, a smart speaker, a smartwatch, and the like, but is not limited thereto. The terminal and the server may be connected directly or indirectly to the server in a wired or wireless communication protocol. This is not limited herein.

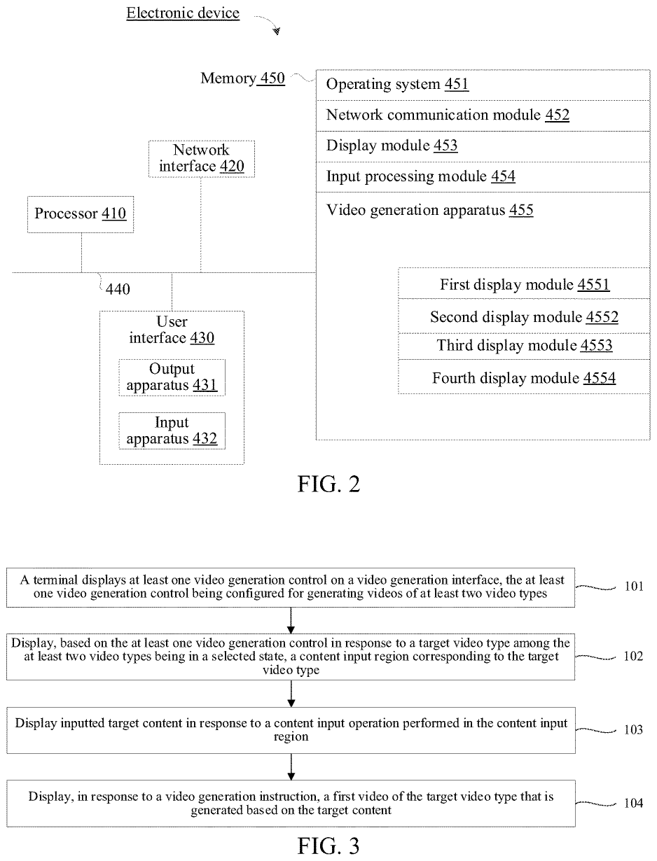

The following describes an electronic device that implements a video generation method according to one or more embodiments. FIG. 2 is a schematic diagram of a structure of an electronic device according to one or more embodiments. The electronic device may be a server or a terminal. An example in which the electronic device is the terminal shown in FIG. 1 is used and the electronic device shown in FIG. 2 includes: at least one processor 410, a memory 450, at least one network interface 420, and a user interface 430. The components in the terminal 400 are coupled together through a bus system 440. The bus system 440 is configured to enable connected communication between these components. In addition to a data bus, the bus system 440 further includes a power bus, a control bus, and a state signal bus. However, for clarity of description, all types of buses in FIG. 2 are marked as the bus system 440.

The processor 410 may be an integrated circuit chip having a signal processing capability, for example, a general purpose processor, a digital signal processor (DSP), another programmable logic device, discrete gate or transistor logic device, or discrete hardware component, or the like. The general purpose processor may be a microprocessor or any conventional processor, or the like.

The user interface 430 includes one or more output apparatuses 431 capable of displaying media content, including one or more speakers and/or one or more visual display screens. The user interface 430 further includes one or more input apparatuses 432, including a user interface component helpful to typing, such as a keyboard, a mouse, a microphone, a touch display screen, a camera, other input buttons, and a control.

The memory 450 may be a removable memory, an unremovable memory, or a combination of both a removable memory and an unremovable memory. An exemplary hardware device includes a solid-state memory, a hard disk drive, an optical disk drive, and the like. The memory 450 alternatively includes one or more storage devices away from the processor 410 in physical positions.

The memory 450 includes a volatile memory or a non-volatile memory, or may include both a volatile memory and a non-volatile memory. The non-volatile memory may be a read only memory (ROM), and the volatile memory may be a random access memory (RAM). The memory 450 described in this embodiment is to include any other suitable type of memories.

In some embodiments, the memory 450 may store data to support various operations. Examples of the data include a program, a module, and a data structure or other subsets or supersets, which are exemplified below.

An operating system 451 includes a system program configured for processing various basic system services and performing hardware-related tasks, for example, a framework layer, a core library layer, a drive layer, and the like, to implement various basic services and process hardware-based tasks.

A network communication module 452 is configured to reach another electronic device through one or more (wired or wireless) network interfaces 420. An exemplary network interface 420 includes Bluetooth, wireless fidelity (Wi-Fi), a universal serial bus (USB), and the like.

A presentation module 453, also referred to as a display module 453, is configured to enable display of information through the one or more output apparatuses 431 (for example, a display screen and a speaker) associated with the user interface 430 (for example, a user interface configured to operate a peripheral device and display content and information).

An input processing module 454 is configured to detect one or more user inputs or interactions from the input apparatuses 432 and translate the detected inputs or interactions.

In some embodiments, an apparatus provided in one or more embodiments may be implemented by using software. FIG. 2 shows a video generation apparatus 455 stored in the memory 450. The apparatus 455 may be software in a form of a program, a plug-in, and the like, including the following software modules: a first display module 4551, a second display module 4552, a third display module 4553, and a fourth display module 4554. These modules are logical and may be combined in different manners or further split based on functions implemented. The functions of the modules are described below.

In some other embodiments, the apparatus according to one or more embodiments may be implemented in a hardware manner. For example, the video generation apparatus according to one or more embodiments may be a processor in the form of a hardware decoding processor, programmed to perform the video generation method according to one or more embodiments. For example, the processor in the form of the hardware decoding processor may use one or more application specific integrated circuits (ASIC), a DSP, a programmable logic device (PLD), a complex programmable logic device (CPLD), a field-programmable gate array (FPGA), or other electronic components.

In some embodiments, the terminal or the server may implement the video generation method provided in one or more embodiments by running a computer program. For example, the computer program may be a native program or a software module in an operating system; may be a native application (APP), namely, a native client, a program that needs to be run by being installed in an operating system, such as an instant messaging APP or a webpage browser APP; or may be a mini program, namely, a program that only needs to be run by being downloaded into a browser environment; or may be a mini program that can be embedded in any APP. In a word, the foregoing computer program may be any form of client, module, or plug-in.

Based on the foregoing descriptions of the video generation system and the electronic device that are provided in one or more embodiments, the following describes a video generation method provided in one or more embodiments. In some embodiments, the video generation method may be implemented by a terminal or a server alone, or by a terminal and a server collaboratively. An example in which the server 400 in FIG. 1 performs the video generation method provided alone is used for description. FIG. 3 is a schematic flowchart of a video generation method according to one or more embodiments, which will then be described with reference to operations shown in FIG. 3.

Operation 101: A terminal displays at least one video generation control on a video generation interface, the at least one video generation control being configured for generating videos of at least two video types.

In some embodiments, the terminal is installed with a client that supports video generation. When a user opens the client in the terminal and the terminal runs the client, the terminal may display the video generation interface based on the client, and display the at least one video generation control on the video generation interface. The at least one video generation control is configured for generating the videos of the at least two video types. The video type includes long video and short video.

In some embodiments, at least two video generation controls are provided, and different video generation controls correspond to different video types, so that the process of displaying the video generation interface may be: displaying, in response to an opening instruction for the video generation interface, the video generation interface including the at least two video generation controls; and in response to a video generation control, corresponding to the target video type, on the video generation interface being in a selected state, determining that the target video type is in the selected state.

By applying the foregoing embodiment, different video types may be controlled to be in selected states by selecting different video generation controls, so as to generate videos of corresponding video types in a subsequent process. In this way, it not only enhances video generation efficiency, but also enhances human-computer interaction efficiency and increases a utilization rate of hardware resources of an electronic device.

In some other embodiments, one video generation control is provided, so that the process of displaying the video generation interface may be: in response to an opening instruction for the video generation interface, displaying the video generation interface including one video generation control; displaying at least two video type selection controls in response to a trigger operation for the video generation control, different video type selection controls being configured for selecting different video types; and displaying, in response to a selection operation for a target video type selection control among the at least two video type selection controls, a video generation interface of the target video type indicated by the target video type selection control, and determining that the target video type indicated by the target video type selection control is in the selected state.

When the video generation interface is displayed and one video generation control is provided, after the at least two video type selection controls are displayed in response to the trigger operation for the video generation control, if a user triggers a video type selection control, it is determined that a corresponding video type is in a selected state.

Operation 102: Display, based on the at least one video generation control in response to a target video type among the at least two video types being in a selected state, a content input region corresponding to the target video type.

When the video generation interface is displayed and a plurality of video generation controls are provided, one video generation control may be automatically selected, or one video generation control may be controlled to be in a selected state based on a selection operation of a user, that is, the target video type is in the selected state. For example, a blank video generation interface and at least two video generation controls that are in unselected states are first displayed, and then in response to a selection operation for a target video generation control among the at least two video generation controls, the target video generation control among the at least two video generation controls is controlled to be in the selected state, to display the content input region. Alternatively, one of the at least two video generation controls is set in advance to be in the selected state, so that when the video generation interface is displayed, a video generation interface including the target video generation control that is in the selected state is first displayed, to display the content input region.

Based on this, in the process of determining, in response to the video generation control, corresponding to the target video type, on the video generation interface being in the selected state, that the target video type is in the selected state, the target video generation control that is in the selected state may be determined based on the selection operation of the user after the blank video generation interface is displayed, or may be set in advance, that is, directly determined when the video generation interface is displayed, or may be determined after the video generation control that is set in advance to be in the selected state is displayed and based on a selection operation performed by the user on another video generation control that is in the unselected state. This embodiment of the disclosure does not impose limitations on this.

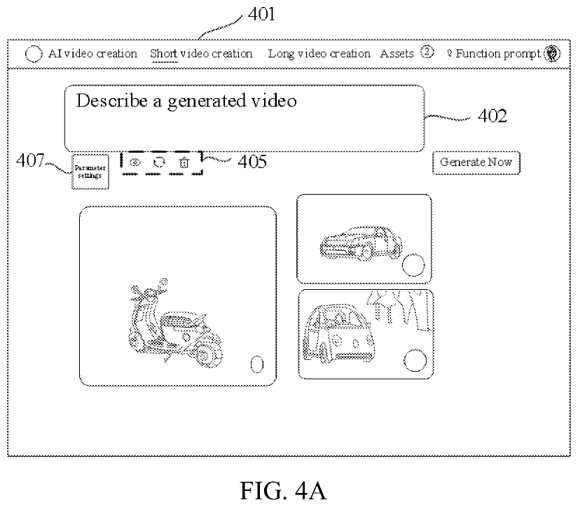

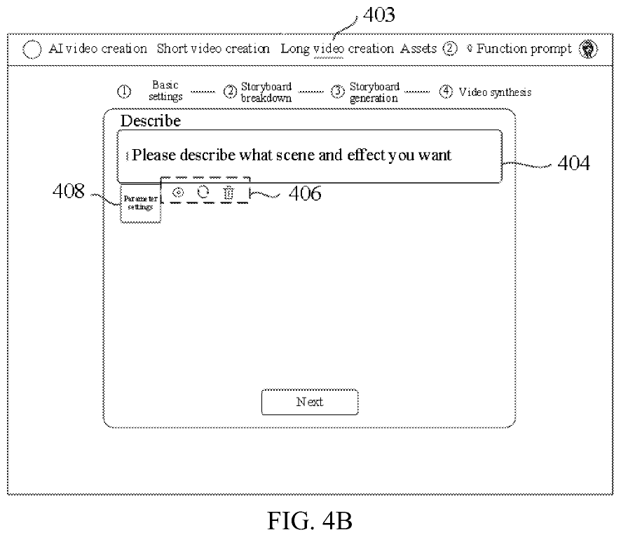

For example, FIG. 4A and FIG. 4B are schematic diagrams of displaying of a content input region according to one or more embodiments. According to an embodiment of FIG. 4A, when the target video generation control is a short video generation control, in response to the short video generation control indicated by 401 being in a selected state, a content input region indicated by 402 is displayed. According to an embodiment of FIG. 4B, when the target video generation control is a long video generation control, in response to the long video generation control indicated by 403 being in a selected state, a content input region indicated by 404 is displayed.

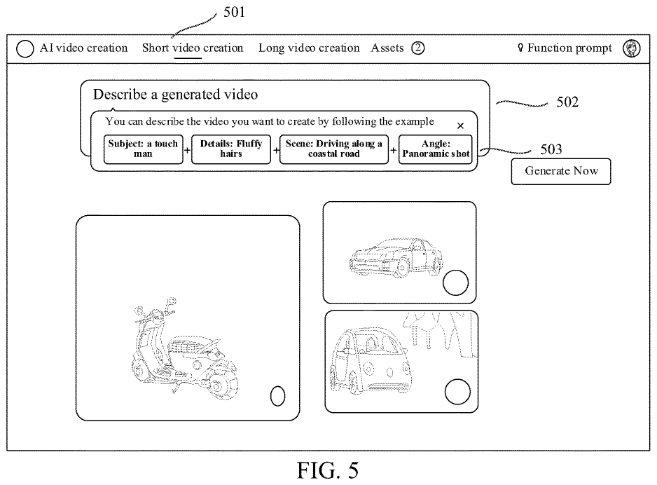

In some embodiments, based on the at least one video generation control, in response to the target video type among the at least two video types being in the selected state, when the content input region corresponding to the target video type is displayed, guide information may be further displayed in a form of a floating layer on a top layer of the content input region. The guide information is configured for guiding execution of an input operation based on the content input region. For example, FIG. 5 is a schematic diagram of guide information according to one or more embodiments. Based on FIG. 5, when the target video generation control is a short video generation control, in response to the short video generation control indicated by 501 being in a selected state, when a content input region indicated by 502 is displayed, guide information indicated by 503 is displayed in a form of a floating layer.

In some embodiments, a user may directly click/tap, when running the client, a function control configured for displaying the video generation interface to display the video generation interface. That is, the video generation interface is displayed in response to a trigger operation for the function control configured for displaying the video generation interface. In some embodiments, the video generation interface may be displayed based on a link shared by another user. Before the video generation interface is displayed, if a current account has a playback permission on another video, a playback interface of the another video may be displayed in response to a display instruction triggered based on a share link for the another video, and detailed information of the another video and a fourth new video generation control are displayed on the playback interface. Thus, the process of displaying the video generation interface may be: displaying the video generation interface in response to a trigger operation for the fourth new video generation control.

The fourth new video generation control is configured for jumping from the playback interface to the video generation interface including the blank content input region, and generating a new video based on the video generation interface. That is, after the video generation interface including the blank content input region is displayed in response to the trigger operation for the fourth new video generation control, target content is inputted to the blank content input region, and a video of the target video type is generated based on the inputted target content. The detailed information includes at least one of duration, a size, a content description, prompt information of whether an audio is included, a resolution, and a key image frame of the another video, where the key image frame is configured for indicating a cover of the another video, an image inputted when the another video is generated, or the like. The content description is configured for indicating a text inputted when the another video is generated, or configured for indicating text content obtained by analyzing video content of the another video after the another video is generated. Whether an audio is included may indicate whether an audio is inputted when the another video is generated, or may indicate whether an audio is generated when the another video is generated. This embodiment does not impose limitations on this.

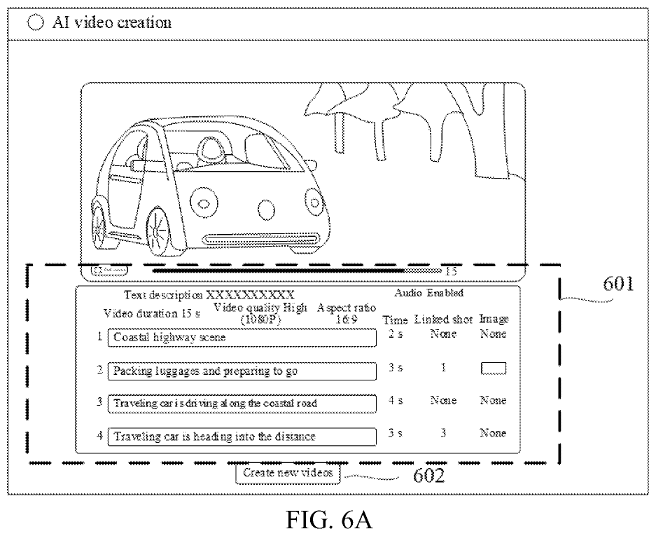

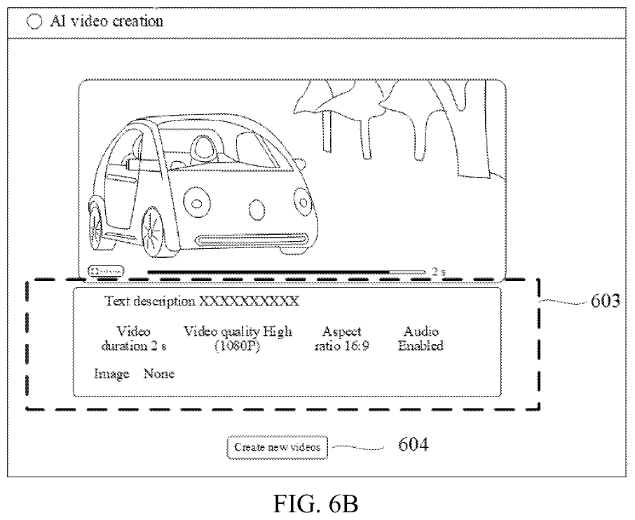

FIG. 6A and FIG. 6B are schematic diagrams of a playback interface of another video according to one or more embodiments. When the another video is a long video, a displayed details interface is shown by FIG. 6A. Detailed information of the another video is shown by a dashed box 601. In response to a trigger operation for a fourth new video generation control indicated by 602, the video generation interface shown by FIG. 4B is displayed. When the another video is a short video, a displayed playback interface is shown by FIG. 6B. Detailed information of the another video is shown by a dashed box 603. In response to a trigger operation for a fourth new video generation control indicated by 604, the video generation interface shown by FIG. 4A is displayed.

In some embodiments, when the current account does not have a playback permission of the another video, permission prompt information is displayed. The permission prompt information is configured for prompting that a target object does not have a playback permission of the another video.

Whether the current account has a permission may be set by an account that generates the another video, or may be determined based on information such as a level of the current account. This embodiment does not impose limitations on this.

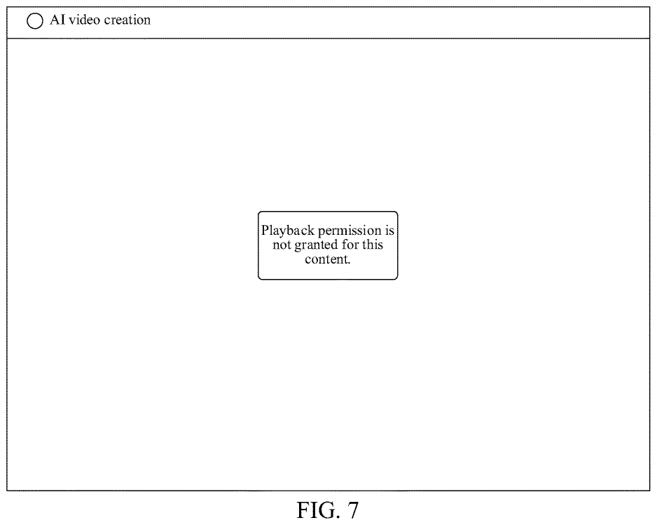

FIG. 7 is a schematic diagram of permission prompt information according to one or more embodiments. Based on FIG. 7, when the current account does not have the playback permission of the another video, the permission prompt information shown in FIG. 7 is displayed.

In some embodiments, when the at least one video generation control is displayed on the video generation interface, at least one video template may be further displayed. In response to a selection operation for a target video template among the at least one video template, a template content description of the target video template and a corresponding first editing control are displayed. The first editing control is configured for generating the first video of the target video type based on the template content description. In response to a trigger operation for the first editing control, the trigger operation is determined as an input operation for the content input region. Thus, the process of displaying inputted target content in response to a content input operation for the content input region may be displaying the template content description of the target video template in the content input region in response to the trigger operation for the first editing control, and the displayed template content description is determined as the inputted target content.

The video template is a pre-generated video. The first editing control is configured for generating the first video of the target video type based on the template content description. It means that the template content description of the target video template is backfilled to the content input region, and a first video associated with the target video template is generated based on the template content description of the target video template. The at least one video template may be uploaded by another user, or may be uploaded by a current user. The selection operation for the target video template among the at least one video template is configured for indicating to control the target video template to be in the selected state, rather than clicking/tapping the target video template. For example, the user may move a cursor controlled by a mouse to be located above the target video template. That is, when the cursor controlled by the user is moved to be above the target video template, it may be considered that the selection operation for the target video template is triggered.

Then, in response to the selection operation for the target video template among the at least one video template, the template content description of the target video template and the corresponding first editing control are displayed on the target video template. When a click/tap operation for the first editing control is performed, the template content description of the target video template is backfilled to the content input region. That is, in response to the trigger operation for the first editing control, a video generation interface that includes the content input region carrying the template content description of the target video template is displayed.

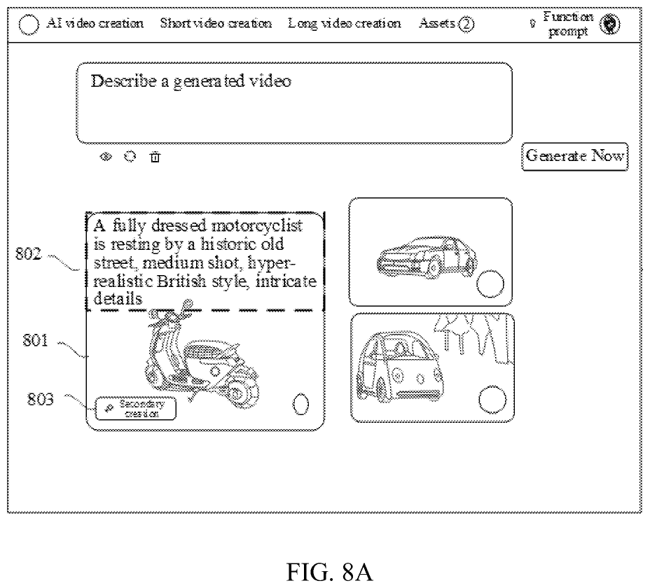

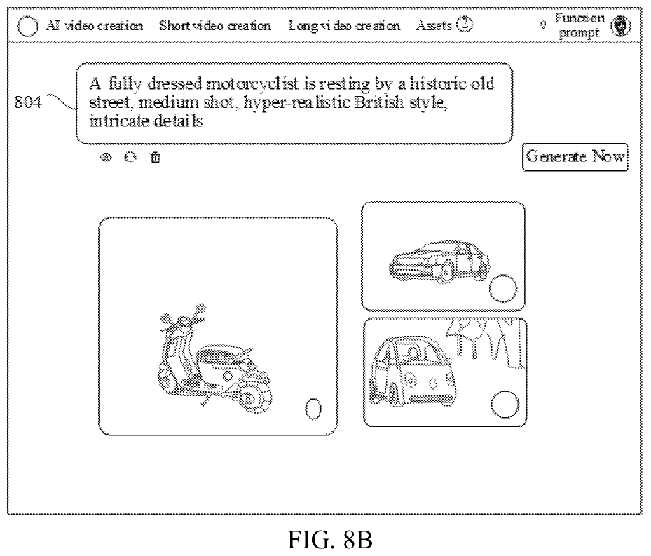

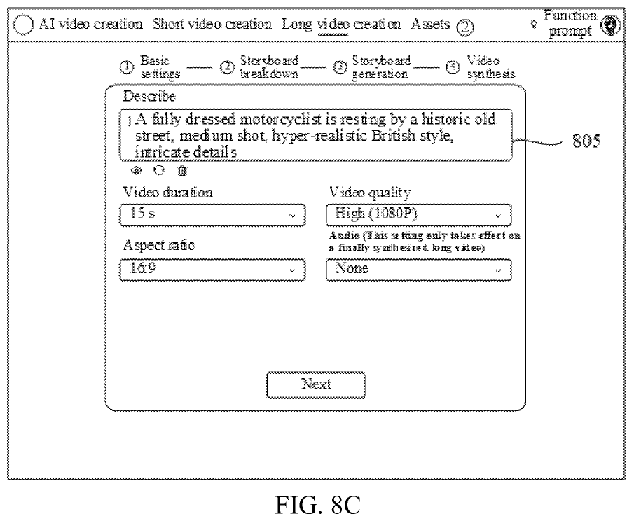

FIGS. 8A, 8B, and 8C are schematic diagrams of at least one video template according to one or more embodiments. In FIG. 8A, in response to a selection operation for a target video template indicated by 801, a template content description of a target video template indicated by a dashed box 802 and a corresponding first editing control indicated by 803 are displayed. Then, in response to a click/tap operation for the first editing control, when the target video template is a short video, an interface shown by FIG. 8B is displayed. 804 in FIG. 8B indicates the content input region carrying the template content description of the target video template.

When the target video template is a long video, a last interface when the long video is generated is displayed. For example, the last interface is a video generation interface shown by FIG. 8C. 805 in FIG. 8C indicates the content input region carrying the template content description of the target video template. In some embodiments, the last interface is a storyboard breakdown interface mentioned below (for example, when a target video, i.e. a video of the target video type, is generated directly based on the storyboard breakdown interface, the last interface is the storyboard breakdown interface), or the last interface is a storyboard generation interface mentioned below (for example, when a target video is generated directly based on a storyboard generation interface, or after a storyboard generation interface is displayed based on the storyboard breakdown interface, when a target video is generated based on the storyboard generation interface, the last interface is the storyboard generation interface). This embodiment does not impose limitations on this.

By applying the foregoing embodiment, a video associated with the target video template may be quickly generated based on the first editing control displayed based on the selection operation for the target video template among the at least one video template. In this way, if a user is satisfied with the target video template, the user can directly generate the video associated with the target video template. In this way, human-computer interaction efficiency is enhanced, and video generation efficiency is also enhanced.

In some embodiments, at least one video template may be further displayed when the at least one video generation control is displayed on the video generation interface. In response to a trigger operation for a target video template among the at least one video template, a details interface including detailed information of the target video template is displayed. The details interface further includes at least one of a second editing control and a first new video generation control. The second editing control is configured for regenerating the first video of the target video type based on a template content description, and the first new video generation control is configured for re-inputting the target content to the content input region and generating the first video of the target video type based on the re-inputted target content. In response to a trigger operation for the second editing control, it jumps from the details interface to the video generation interface that includes a content input region carrying the template content description of the target video template. In response to a trigger operation for the first new video generation control, it jumps from the details interface to the video generation interface including a blank content input region.

Thus, in a subsequent process, the process of displaying the inputted target content in response to the content input operation performed in the content input region, when the trigger operation for the second editing control is received, the trigger operation is determined as the content input operation, and the template content description displayed in the content input region is determined as the inputted target content; and when the trigger operation for the first new video generation control is received, the inputted target content is displayed in response to the content input operation performed in the blank content input region.

A function of the second editing control is similar to a function of the first editing control. That the first new video generation control is configured for re-inputting the target content to the content input region, and generating the first video of the target video type based on the re-inputted target content means that when the trigger operation for the first new video generation control is received, it jumps from the details interface to the video generation interface including the blank content input region, so that a user can input the target content to the blank content input region, and generate the first video of the target video type based on the inputted target content. Meanwhile, the trigger operation for the target video template among the at least one video template may be a click/tap operation for the target video template. The detailed information includes at least one of duration, a size, a content description, prompt information of whether an audio is included, a key image frame, and a resolution of the target video template. The key image frame is configured for indicating a cover of the target video template, an image inputted when the target video template is generated, or the like. The content description is configured for indicating a text inputted when the target video template is generated (that is, content inputted to the content input region when the target video template is generated), or configured for indicating text content obtained by analyzing video content of the target video template after the target video template is generated. Whether an audio is included may indicate whether an audio is inputted when the target video template is generated, or may indicate whether an audio is generated when the target video template is generated. This embodiment does not impose limitations on this.

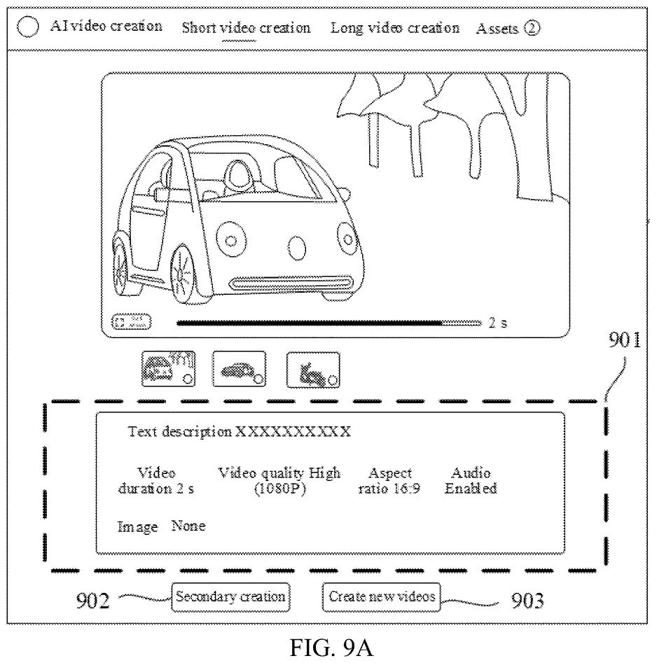

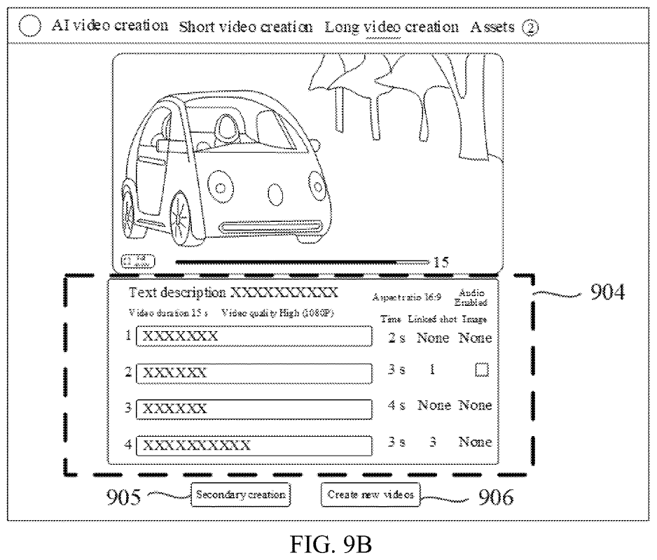

FIGS. 9A and 9B are schematic diagrams of a details interface including detailed information of a target video template according to one or more embodiments. In FIG. 8A, when the target video template is a short video, in response to a trigger operation for the target video template indicated by 801, a details interface shown by FIG. 9A is displayed. A dashed box 901 indicates detailed information of the target video template, 902 indicates a second editing control, and 903 indicates a first new video generation control, so that an interface shown by FIG. 8B is displayed in response to a trigger operation for the second editing control, or, in response to a trigger operation for the first new video control, the video generation interface shown by FIG. 4A is displayed.

In FIG. 8A, when the target video template is a long video, in response to the trigger operation for the target video template indicated by 801, a details interface shown by FIG. 9B is displayed. A dashed box 904 indicates the detailed information of the target video template, 905 indicates the second editing control, and 906 indicates the first new video generation control, so that the video generation interface shown by FIG. 4B is displayed in response to the trigger operation for the first new video control. In some embodiments, in response to the trigger operation for the second editing control, a last interface when the long video is generated is displayed. For example, the last interface is a video generation interface shown by FIG. 8C. 805 in FIG. 8C indicates the content input region carrying the template content description of the target video template. In some embodiments, the last interface is a storyboard breakdown interface mentioned below (for example, when a target video, i.e. a video of the target video type, is generated directly based on the storyboard breakdown interface, the last interface is the storyboard breakdown interface), or the last interface is a storyboard generation interface mentioned below (for example, when a target video is generated directly based on a storyboard generation interface, or after a storyboard generation interface is displayed based on the storyboard breakdown interface, when a target video is generated based on the storyboard generation interface, the last interface is the storyboard generation interface). This embodiment does not impose limitations on this.

By applying the foregoing embodiment, if a user is satisfied with the detailed information corresponding to the target video template, a video associated with the target video template may be quickly generated based on the second editing control on the details interface. In this way, human-computer interaction efficiency is enhanced, and video generation efficiency is also enhanced. Meanwhile, if the user is not satisfied with the detailed information corresponding to the target video template, a new video can be quickly generated based on the first new video control on the details interface. Therefore, the human-computer interaction efficiency is enhanced, and the video generation efficiency is also enhanced. In this way, based on the second editing control and the first new video control, the human-computer interaction efficiency and the video generation efficiency are enhanced, and different choices are provided for the user, thereby enhancing a user experience.

Operation 103: Display inputted target content in response to a content input operation performed in the content input region.

The content input operation in the content input region may indicate to input at least one of an image, a text, and an audio, so that the target content may be at least one of a corresponding image, text, and audio. At least one inputted content editing control may be further displayed in an associated region of the content input region. The at least one inputted content editing control aims at an inputted image and audio, and includes a preview control, a re-upload control, and a deletion control. After the inputted image or audio is displayed in response to an input operation for the content input region, the inputted image and audio are previewed in response to a trigger operation for the preview control, or a re-inputted image or audio is displayed in response to a re-upload operation triggered based on the re-upload control, or the inputted image or audio is deleted in response to a trigger operation for the deletion control. For example, in FIG. 4A, the dashed box 405 indicates three inputted content editing controls, where a 1^{st} control is the preview control, a 2^{nd} control is the re-upload control, and a 3^{rd} control is the deletion control. Correspondingly, in FIG. 4B, the dashed box 406 indicates three inputted content editing controls, where a 1^{st} control is the preview control, a 2^{nd} control is the re-upload control, and a 3^{rd} control is the deletion control.

In some embodiments, a first confirmation control that is in an inactive state may be further displayed in response to the target video type among the at least two video types being in the selected state. The first confirmation control is configured for confirming the target content inputted to the content input region. Therefore, after the inputted target content is displayed in response to the content input operation performed in the content input region, the first confirmation control may be further switched from the inactive state to an active state. The video generation instruction is received in response to a trigger operation for the first confirmation control that is in the active state.

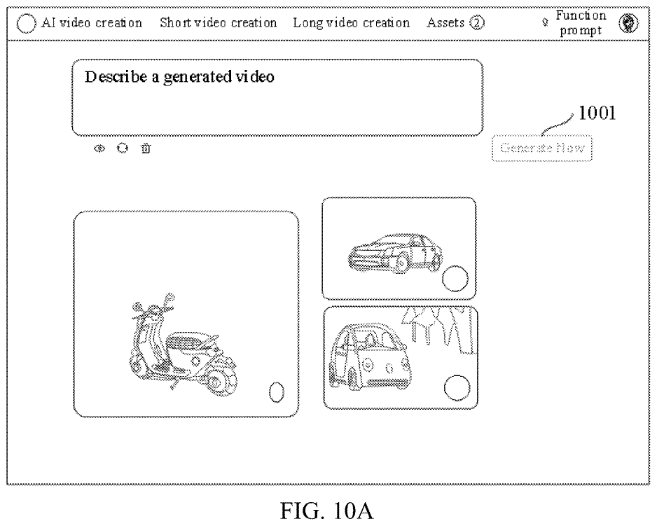

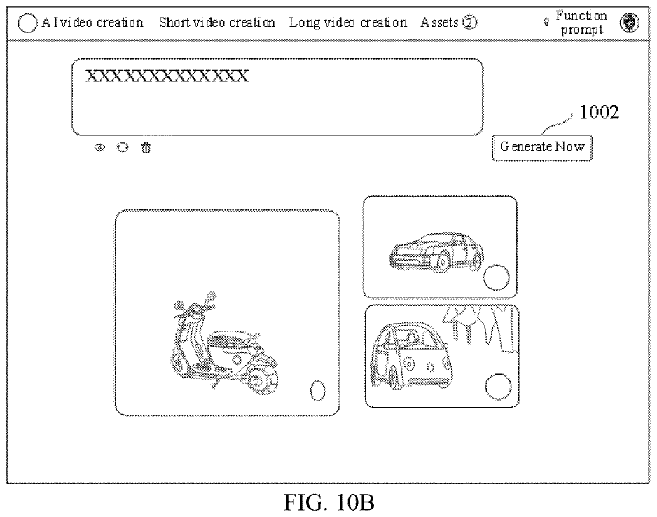

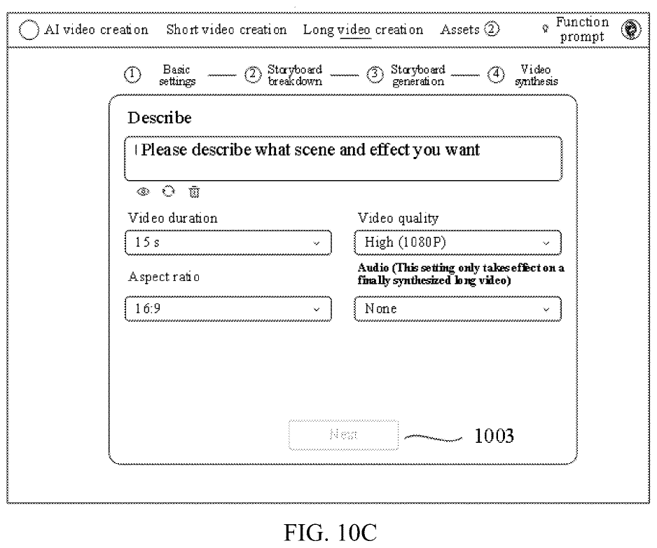

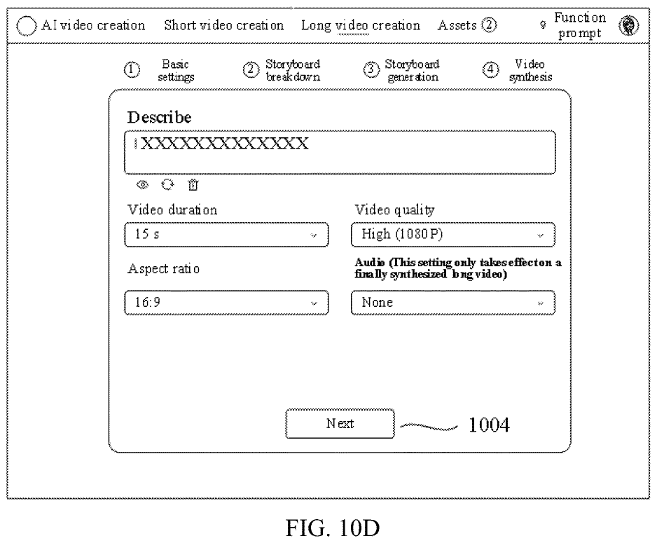

The inactive state is configured for indicating that the first confirmation control is in a gray state and cannot be triggered, and the active state is configured for indicating that the first confirmation control is in a normal state and can be triggered. For example, FIGS. 10A-10D are schematic diagrams of a first confirmation control according to one or more embodiments. According to FIG. 10A, when the target video generation control is a short video generation control, in response to a short video type being in a selected state, a first confirmation control that is in an inactive state, which is indicated by 1001 in FIG. 10A, is displayed. After the inputted target content is displayed in response to the content input operation performed in the content input region, as shown by 1002 in FIG. 10B, the first confirmation control is switched from the inactive state to an active state, so that the video generation instruction is received in response to a trigger operation for the first confirmation control that is in the active state.

According to FIG. 10C, when the target video generation control is a long video generation control, in response to a long video type being in a selected state, a first confirmation control that is in an inactive state, which is indicated by 1003 in FIG. 10C, is displayed. After the inputted target content is displayed in response to the content input operation performed in the content input region, as shown by 1004 in FIG. 10D, the first confirmation control is switched from the inactive state to an active state, so that the video generation instruction is received in response to a trigger operation for the first confirmation control that is in the active state.

In some embodiments, when the content input region is displayed, a parameter setting region is further displayed on the video generation interface. The parameter setting region is configured for setting a parameter of the first video (i.e. a video to be generated). A video parameter set for the first video of the target video type is displayed in response to a parameter setting operation based on the parameter setting region. Thus, a generated first video of the target video type that has the video parameter is displayed based on the target content in response to the video generation instruction. For example, when parameter setting on the first video is completed, the video generation instruction is received in response to the trigger operation for the first confirmation control that is in the active state. Thus, in a subsequent process, a first video of the target video type that has a target parameter is generated in response to the video generation instruction. Parameters of a video include duration, quality, an aspect ratio, resolution, and the like of the video.

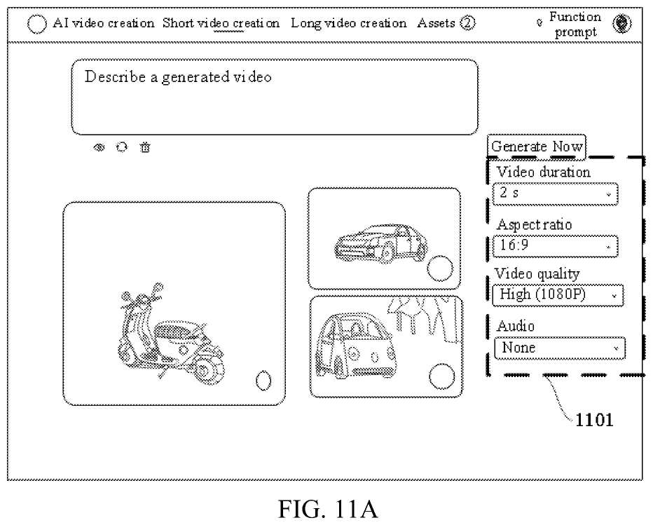

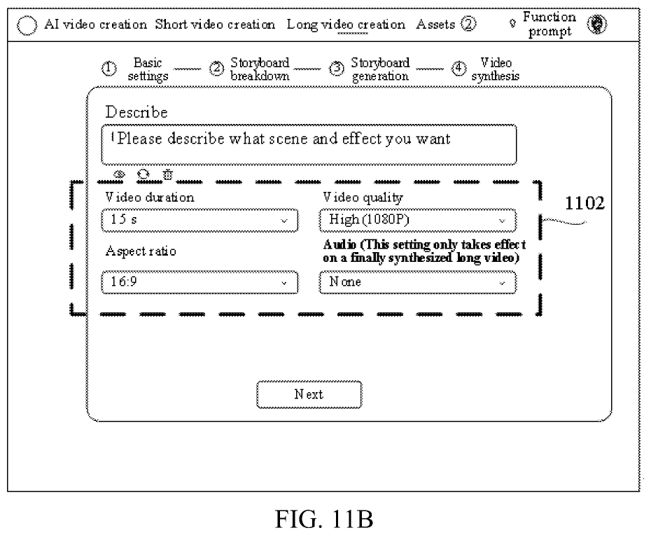

FIGS. 11A and 11B are schematic diagrams of displaying of a parameter setting region according to one or more embodiments. According to FIG. 11A, when the target video generation control is a short video generation control, a parameter setting region indicated by a dashed box 1101 is displayed. In some embodiments, according to FIG. 11B, when the target video generation control is a long video generation control, a parameter setting region indicated by a dashed box 1102 is displayed. Thus, when parameter setting on a target video is completed, the video generation instruction is received in response to a trigger operation for the first confirmation control that is in the active state, to generate a corresponding short video or long video.

Before the parameter setting is performed, a default parameter may be displayed. For example, when the target video generation control is the short video generation control, the default parameter may be: there is no effect by default, video quality is 896*512 by default, an aspect ratio is 7:4 by default, video duration is 4 s by default, and there is no audio by default. When the target video generation control is a long video generation control, the default parameter may be: video duration is 6 s by default, video quality is 896*512 by default, an aspect ratio is 7:4 by default, and there is no audio. When the parameter setting is not performed, the trigger operation for the first confirmation control that is in the active state is directly performed. Therefore, the parameter of the first video of the target video type that is generated in the subsequent process is the default video parameter. If the parameter setting is performed, the parameter of the first video of the target video type that is generated in the subsequent process is the target parameter.

By applying the foregoing embodiment, the video parameter of the generated first video is set through the parameter setting region, to generate a video that better meets user requirements, thereby not only enriching diversity of a generated video, but also enhancing an effect of the generated video and a user experience.

In some embodiments, the video generation interface includes a parameter setting control. The parameter setting control is configured for setting the parameter of the generated first video. That is, the parameter setting region may be displayed based on triggering of the parameter setting control. The parameter setting region is displayed in response to a trigger operation for the parameter setting control. A target parameter set for the first video is displayed based on the parameter setting region in response to a parameter setting operation for the first video. Thus, the process of displaying the first video generated based on the target content in response to the video generation instruction may be: when the setting of the parameter of the first video is completed, in response to the video generation instruction, displaying the first video generated based on the target content. Therefore, in the subsequent process, the first video having the target parameter is generated in response to the video generation instruction. For example, in FIG. 4A, a control indicated by 407 is the parameter setting control, and correspondingly, in FIG. 4B, a control indicated by 408 is the parameter setting control.

As described above, the video types include long video and short video. A plurality of video generation controls may be provided. For different video types, processes of receiving the video generation instruction are also different. Next, for the video generation controls of different video types, the process of receiving the video generation instruction is described.

Case: the target video generation control includes the short video generation control and the target video type includes the short video type.

In some embodiments, when the first video is a short video, for example, when the parameter setting on the first video is completed, the video generation instruction may be received directly based on the foregoing process in response to the trigger operation for the first confirmation control that is in the active state, or the video generation instruction may be received directly in response to the trigger operation for the first confirmation control that is in the active state.

Case: the target video generation control includes the long video generation control and the target video type includes the long video type.

In some embodiments, when the first video is a long video, the long video includes a plurality of storyboards. After the inputted target content is displayed in response to the content input operation performed in the content input region, a storyboard breakdown interface may be displayed in response to a confirmation instruction for the target content, and at least two storyboard texts determined based on the target content are displayed on the storyboard breakdown interface. Each storyboard text corresponds to one storyboard, and a storyboard text is configured for describing a corresponding storyboard. Thus, in a subsequent process, in response to a video generation instruction triggered based on the at least two storyboard texts, a generated first video of the long video type that includes the storyboards corresponding to the storyboard texts is displayed.

One storyboard herein is configured for indicating one video clip. A plurality of video clips are combined to form a final first video. After the inputted target content is displayed, the target content is parsed to obtain text content corresponding to the target content, and then the text content is segmented to obtain a plurality of text paragraphs, so that the plurality of text paragraphs are determined as a plurality of storyboard texts and are then displayed on the storyboard breakdown interface.

Meanwhile, the confirmation instruction for the at least two storyboard texts may be triggered through a second confirmation control, and the storyboard breakdown interface further includes the second confirmation control, so that after the at least two storyboard texts determined based on the target content are displayed on the storyboard breakdown interface, the confirmation instruction for the at least two storyboard texts may be further received in response to a trigger operation for the second confirmation control.

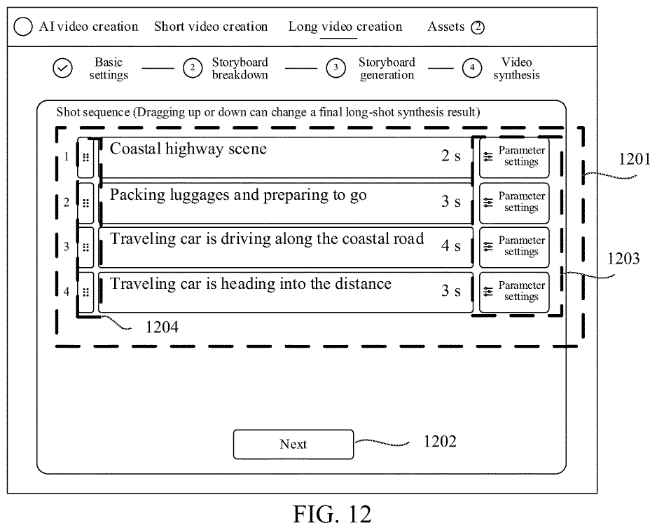

FIG. 12 is a schematic diagram of a storyboard breakdown interface according to one or more embodiments. Based on FIG. 12, a dashed box 1201 indicates four storyboard texts. Each storyboard text is configured for describing content of a corresponding storyboard, and 1202 indicates a second confirmation control, so that the confirmation instruction for the at least two storyboard texts is received in response to a trigger operation for the second confirmation control.

By applying the foregoing embodiment, the target content is broken down into at least two storyboard texts, and then corresponding storyboards are generated based on the storyboard texts, so that the first video of the long video type is generated based on the at least two storyboards. In this way, a user can better learn about a generated video, and it is also convenient for the user to adjust the generated video based on storyboards in a subsequent process.

In some embodiments, a storyboard text quantity adjustment control may be further displayed. The storyboard text quantity adjustment control is configured for adjusting a quantity of storyboard texts, such as adding a new storyboard text or deleting an original storyboard text. In response to a storyboard text quantity adjustment operation triggered for the storyboard text quantity adjustment control, such as a storyboard text addition operation or a storyboard text deletion operation, a storyboard text whose quantity is adjusted is displayed on the storyboard breakdown interface, for example, an added new storyboard text or a deleted storyboard text. The video generation instruction is received in response to a confirmation operation triggered based on at least two storyboard texts including the new storyboard text.

In an example, adding a new text is used as an example. Specifically, in response to a trigger operation for the storyboard text quantity adjustment control, a text input box is displayed in an associated region of the at least two storyboard texts. An inputted text is displayed in response to an input operation for the text input box. An added new storyboard text is displayed in response to a confirmation instruction for the inputted text. The new storyboard text is associated with the inputted text.

The associated region of the at least two storyboard texts may be, for example, a region below the at least two storyboard texts, and the confirmation instruction for the inputted text may be triggered through a confirmation control. This embodiment does not impose limitations on this.

By applying the foregoing embodiment, the new storyboard text is added or the original storyboard text is deleted based on the storyboard text quantity adjustment control. In this way, a user can perform more detailed editing on a generated video, so as to generate a video that better meets user requirements, thereby enhancing an effect of the generated video and a user experience.

In some embodiments, parameters of the storyboards of the corresponding storyboard texts may be further set. The storyboard texts are associated with parameter setting controls, and the parameter setting controls are configured for setting storyboard parameters of the storyboards corresponding to the corresponding storyboard texts. Therefore, after the storyboard breakdown interface is displayed, a target storyboard parameter set for a target storyboard text may be further displayed in response to a parameter setting operation triggered based on the parameter setting control associated with the target storyboard text. In response to a confirmation instruction for the target storyboard parameter, the storyboard parameter of the storyboard corresponding to the target storyboard text is updated into the target storyboard parameter. Thus, in a subsequent process, the storyboard parameter of the target storyboard included in a generated first video, that is, the first video of the long video type, is the target storyboard parameter.

The target storyboard text herein may be some of the at least two storyboard texts, or may be all storyboard texts. This embodiment does not impose limitations on this. Meanwhile, after the trigger operation for the parameter setting control is performed, the parameter setting region is displayed, so as to implement the parameter setting operation based on the parameter setting region. The parameter setting region herein is as described above, and details are not described again.

For example, continuing to refer to FIG. 12, a control indicated by a dashed box 1203 is the parameter setting control. Thus, the parameter setting region is displayed in response to the trigger operation for the parameter setting control corresponding to one storyboard text, and the target parameter set for the target storyboard text is displayed in response to the parameter setting operation triggered based on the parameter setting region. In this way, the parameters of the storyboards corresponding to the storyboard texts are sequentially set, so that a finally generated first video conforms to the set parameters.

In some embodiments, an arrangement sequence of storyboard texts may be changed. The at least two storyboard texts have an arrangement sequence. Videos formed by the storyboards corresponding to the at least two storyboard texts in different arrangement sequences have different content, and the storyboard texts are associated with an arrangement sequence adjustment control. Thus, after the storyboard breakdown interface is displayed, in response to an arrangement sequence adjustment operation triggered for the at least two storyboard texts based on the arrangement sequence adjustment control, the arrangement sequence of the at least two storyboard texts is changed from a current arrangement sequence to a target arrangement sequence. Thus, in a subsequent process, a video of the long video type that is generated based on the target arrangement sequence and includes the at least two storyboards is displayed based on the at least two storyboard texts in response to the video generation instruction.

As described above, the first video is formed by combining the at least two storyboards, and the storyboards and the storyboard texts have a correspondence relationship. Therefore, the arrangement sequence of the at least two storyboard texts also indicates a combination sequence of the at least two storyboards, so that different arrangement sequences of the at least two storyboards cause different combination sequences of the at least two storyboards. Thus, content of the first video is different.

The arrangement sequence adjustment control may be dragged to drag the corresponding storyboard texts, to sort the at least two storyboard texts. Alternatively, by performing a trigger operation for the arrangement sequence adjustment control, input boxes are displayed in the associated regions of the storyboard texts. Thus, inputted sequence numbers for the storyboard texts are displayed in response to an input operation for the input boxes, so as to change the arrangement sequence of the at least two storyboard texts from the current arrangement sequence to the target arrangement sequence.

For example, continuing to refer to FIG. 12, a control indicated by a dashed box 1204 is the arrangement sequence adjustment control which is dragged to drag the corresponding storyboard texts to sort the at least two storyboard texts. The storyboards corresponding to the at least two storyboard texts are combined in a sequence from top to bottom to form the target video, so that in response to the arrangement sequence adjustment operation triggered for the at least two storyboard texts based on the arrangement sequence adjustment control, the arrangement sequence of the at least two storyboard texts is changed, and then the video generation instruction is received based on the changed sequence.

In some embodiments, some storyboard texts may be further selected to generate the first video. In response to a selection operation for one or two target storyboard texts among the at least two target storyboard texts, each target storyboard text is controlled to be in a selected state. Thus, in a subsequent process, a first video of the long video type that includes each target storyboard text is displayed in response to the video generation instruction based on each target storyboard text that is in the selected state.

In some embodiments, the storyboard texts may be further modified. A modified target storyboard text is displayed in response to a text modification operation for a target storyboard text among the at least two storyboard texts, so that in a subsequent process, a first video of the long video type that includes the modified target storyboard text is displayed in response to the video generation instruction based on the modified target storyboard text.

In some embodiments, as described above, the second confirmation control is further displayed on the storyboard breakdown interface. When the second confirmation control is triggered, the video generation instruction may be received, that is, the first video is directly generated. Alternatively, the storyboard generation interface may be displayed. The process of receiving the video generation instruction in response to the confirmation instruction for the at least two storyboard texts may be: displaying the storyboard generation interface in response to a trigger operation for the second confirmation control; displaying a generated storyboard corresponding to each storyboard text on the storyboard generation interface, and displaying a third confirmation control; and receiving the video generation instruction in response to a trigger operation for the third confirmation control.

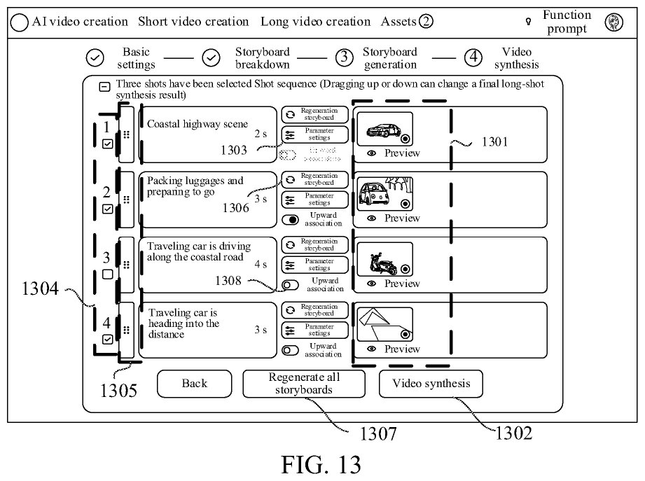

FIG. 13 is a schematic diagram of a storyboard generation interface according to one or more embodiments. As shown in FIG. 12, 1202 indicates a second confirmation control. Thus, the storyboard generation interface shown in FIG. 13 is displayed in response to the confirmation instruction triggered for the at least two storyboard texts based on the second confirmation control. A generated storyboard which is indicated by a dashed box 1301 and corresponds to each storyboard text is displayed on the storyboard generation interface, and a third confirmation control indicated by 1302 is displayed, so that the video generation instruction is received in response to the trigger operation for the third confirmation control.

The storyboard generation interface includes at least two storyboard texts and at least two storyboards. Each storyboard text corresponds to one storyboard. The storyboards are generated based on corresponding storyboard texts. Thus, a video of the target video type that includes the at least two storyboards is displayed in response to the video generation instruction based on the at least two storyboard texts and the at least two storyboards.

In some embodiments, the storyboards are associated with parameter setting controls, and the parameter setting controls are configured for setting storyboard parameters of the corresponding storyboards. After the at least two storyboard texts and the at least two storyboards are displayed on the storyboard generation interface, a target storyboard parameter set for a target storyboard may be further displayed in response to a parameter setting operation triggered based on the parameter setting control associated with the target storyboard. In response to a confirmation instruction for the target storyboard parameter, the storyboard parameter of the target storyboard is updated into the target storyboard parameter. Thus, in a subsequent process, the storyboard parameter of the target storyboard included in a generated first video of the long video type is the target storyboard parameter.

The target storyboard herein may be some of the at least two storyboards, or may be all storyboards. This embodiment does not impose limitations on this. Meanwhile, after the trigger operation for the parameter setting control is performed, the parameter setting region is displayed, so as to implement the parameter setting operation based on the parameter setting region. The parameter setting region herein is as described above, and details are not described herein again.

For example, continuing to refer to FIG. 13, 1303 indicates a parameter setting control of one storyboard, and parameter setting controls of other storyboards are similar. Thus, a parameter setting region is displayed in response to a trigger operation for the parameter setting control corresponding to one storyboard, and then a target storyboard parameter set for a target storyboard is displayed in response to a parameter setting operation triggered based on the parameter setting region. In this way, the storyboard parameters of the storyboards are sequentially set, so that a finally generated first video, that is, the first video of the long video type, conforms to the set storyboard parameters.

In some embodiments, some storyboards may be further selected to generate a first video. After the at least two storyboard texts and the at least two storyboards are displayed on the storyboard generation interface, in response to a selection operation for a first target storyboard among the at least two storyboards, the first target storyboard may be further controlled to be in a selected state. Thus, in a subsequent process, a generated first video of the long video type that includes the first target storyboard is displayed in response to the video generation instruction based on the first target storyboard that is in the selected state and the storyboard text of the first target storyboard.

A quantity of first target storyboards herein may be one, or at least two, for example, two or three. This embodiment does not impose limitations on this.

For example, continuing to refer to FIG. 13, based on a control indicated by a dashed box 1304, in response to a selection operation for first, second, and fourth storyboards, the first, second, and fourth storyboards are controlled to be in selected states, where “√” indicates that corresponding storyboards are in selected states, to generate a first video including the first, second, and fourth storyboards.

By applying the foregoing embodiment, the first target storyboard is selected from the at least two storyboards, and then the first video of the long video type that includes the first target storyboard is generated. In this way, a user can select a storyboard in the first video, thereby generating a video that better meets user requirements. This not only enhances an effect of a generated video and a user experience, but also enhances human-computer interaction efficiency and increases a utilization rate of hardware resource of an electronic device.

In some embodiments, an arrangement sequence of storyboards may be alternatively changed. The at least two storyboards have an arrangement sequence. First videos formed by the at least two storyboards in different arrangement sequences are different. The storyboards are associated with an arrangement sequence adjustment control. The arrangement sequence adjustment control is configured for dragging the corresponding storyboards to adjust the arrangement sequence of the at least two storyboards. After the at least two storyboard texts and the at least two storyboards are displayed on the storyboard breakdown interface, in response to an arrangement sequence adjustment operation triggered for the at least two storyboards based on the arrangement sequence adjustment control, the arrangement sequence of the at least two storyboards is changed from a current arrangement sequence to a target arrangement sequence. Thus, a first video of the long video type that is generated based on the target arrangement sequence and includes the at least two storyboards is displayed based on the at least two storyboard texts and the at least two storyboards in response to the video generation instruction.

As described above, the first video is formed by combining the at least two storyboards. Therefore, the arrangement sequence of the at least two storyboards also indicates a combination sequence of the at least two storyboards, so that different arrangement sequences of the at least two storyboards cause different combination sequences of the at least two storyboards. Thus, content of the first video is different.

The arrangement sequence adjustment control may be dragged to drag the corresponding storyboard texts, to sort the at least two storyboards. Alternatively, by performing a trigger operation for the arrangement sequence adjustment control, input boxes are displayed in the associated regions of the storyboard texts. Thus, inputted sequence numbers for the storyboard texts are displayed in response to an input operation for the input boxes, so as to change the arrangement sequence of the at least two storyboards from the current arrangement sequence to the target arrangement sequence. Alternatively, by performing the trigger operation for the arrangement sequence adjustment control, at least one sorting element is displayed. For example, when the storyboards include a virtual object, the at least one sorting element is duration of the virtual object in each storyboard, a quantity of words spoken, or the like. Thus, in response to a selection operation for a target sorting element among the at least two sorting element, the arrangement sequence of the at least two storyboards is changed from the current arrangement sequence into a target arrangement sequence determined based on the target sorting element. For example, a plurality of storyboards are sorted from long to short based on the duration of the virtual object in each storyboard.

For example, continuing to refer to FIG. 13, a control indicated by a dashed box 1305 is the arrangement sequence adjustment control which is dragged to drag the corresponding storyboard texts to sort the at least two storyboards. The at least two storyboards are combined in a sequence from top to bottom to form the first video, so that in response to the arrangement sequence adjustment operation triggered for the at least two storyboards based on the arrangement sequence adjustment control, the arrangement sequence of the at least two storyboards is changed.

By applying the foregoing embodiment, the first video generated based on the target arrangement sequence is generated by changing the arrangement sequence of the at least two storyboards. In this way, diversity of a generated video is enriched, so that a video that better meets user requirements can be generated, thereby not only enhancing human-computer interaction efficiency and increasing a utilization rate of hardware resources of an electronic device, but also enhancing an effect of the generated video.

In some embodiments, some of the at least two storyboards may be further updated. A storyboard update control configured for updating content of the storyboards is further displayed on the storyboard generation interface, and one or at least two storyboard update controls may be displayed.

When at least two storyboard update controls are displayed, the storyboard update controls are in one-to-one correspondence with the storyboards. After the at least two storyboard texts and the at least two storyboards are displayed on the storyboard generation interface, based on the storyboard update controls, in response to a content update operation for a second target storyboard among the at least two storyboards, the second target storyboard may be updated into a first new storyboard, and content of the first new storyboard is associated with content of the second target storyboard.

The content of the first new storyboard is also generated based on content of the storyboard text of a corresponding storyboard, and is thus associated with the content of the second target storyboard.

For example, continuing to refer to FIG. 13, 1306 indicates a storyboard update control of one storyboard, and storyboard update controls of other storyboards are similar. Thus, in response to a trigger operation for the storyboard update control corresponding to one storyboard, the corresponding storyboard is updated. Alternatively, the storyboard update controls corresponding to the storyboards may be triggered sequentially, to complete update on all the storyboards.

When one storyboard update control is displayed, the storyboard update control is configured for performing a one-click/tap update on the at least two storyboards. After the at least two storyboard texts and the at least two storyboards are displayed on the storyboard generation interface, the at least two storyboards may be further updated to at least two third new storyboards in response to a trigger operation for the storyboard update control. The at least two storyboards and the at least two third new storyboards have a correspondence relationship, and content of the third new storyboards is associated with content of corresponding storyboards.

The content of the third new storyboard is also generated based on content of storyboard texts of corresponding storyboards, and is thus associated with the content of the corresponding storyboards. Meanwhile, when at least two storyboard update controls are displayed, the storyboard update controls configured for performing one-click/tap update on at least two storyboards may still be displayed. This embodiment does not impose limitations on this.

For example, continuing to refer to FIG. 13, 1307 indicates a storyboard update control. Thus, all storyboards are updated in response to a trigger operation for the storyboard update control.

In some embodiments, a first video including updated storyboards by updating the storyboards. In this way, if a user is unsatisfied with a current storyboard, the current storyboard may be further updated, to generate a storyboard that better meets user requirements. Thus, in a subsequent process, an effect of a generated video is enhanced, and human-computer interaction efficiency is also enhanced and a utilization rate of hardware resources of an electronic device is also increased.

In some embodiments, the at least two storyboards have an arrangement sequence. A third target storyboard among the at least two storyboards has an upward association control. The upward association control is configured for updating content of the third target storyboard based on content of a previous storyboard of the third target storyboard. The third target storyboard is any storyboard except a 1^{st} storyboard among the at least two storyboards. After the at least two storyboard texts and the at least two storyboards are displayed on the storyboard generation interface, the third target storyboard may be further updated into a second new storyboard in response to a trigger operation for the upward association control. If at least one third target storyboard is included, at least one upward association control exists. In response to a trigger operation for a target upward association control among the at least one upward association control, a storyboard associated with the target upward association control is updated into a second new storyboard. The second new storyboard is obtained by updating, based on content of a previous storyboard of the storyboard associated with the target upward association control, the content of the storyboard associated with the target upward association control.

Each storyboard is associated with an upward association control, but only the upward association control of the third target storyboard can be enabled, i.e. triggered. The upward association control is configured for: updating the content of the third target storyboard based on the of the previous storyboard of the third target storyboard. That is, content of a current third target storyboard is derived based on the content of the previous storyboard. In this way, a content and effect correlation between the storyboards can be enhanced. For example, if a cluster of birds in a previous storyboard fly by, the content of the third target storyboard is updated based on the content of the previous storyboard, so that the third target storyboard also includes the cluster of birds.

Moreover, after an upward association control is triggered, a corresponding third target storyboard can only be associated upward by default and cannot be associated downward. Furthermore, a top-ranked storyboard cannot be associated upward. In addition, for two adjacent storyboards, if the upward association controls of both the storyboards can be enabled, but cannot be enabled at the same time, after a front storyboard in the two storyboards is associated, namely, after content of the front storyboard is updated, a rear storyboard can be associated. In this way, a waste of resources because the content of the rear storyboard is updated for many times is prevented.

For example, continuing to refer to FIG. 13, 1308 indicates an upward association control of one third target storyboard, and the upward association controls of other third target storyboards are similar. Thus, in response to a trigger operation for the upward association control corresponding to the third target storyboard, the third target storyboard is updated into a second new storyboard based on content of a previous storyboard. The upward association controls corresponding to the third target storyboards may alternatively be triggered in sequence, to complete association on all the storyboards.

By applying the foregoing embodiment, content of a storyboard associated with a target upward association control can be updated based on content of a previous storyboard of the storyboard associated with the target upward association control. In this way, content and effect correlation between storyboards is enhanced, and storyboard editing efficiency is also enhanced.

In some embodiments, a function of the upward association control may be further introduced. Before the third target storyboard is updated into the second new storyboard in response to the trigger operation for the upward association control, function introduction information may be further displayed if an account performing the trigger operation generates the first video of the long video type for the first time. The function introduction information is configured for introducing the function of the upward association control.

The function introduction information may be displayed before the storyboard generation interface is displayed, or may be displayed when the storyboard generation interface is displayed. This embodiment does not impose limitations on this.

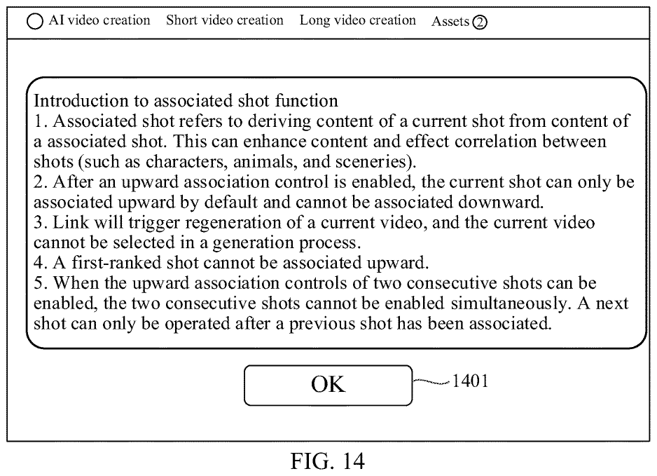

FIG. 14 is a schematic diagram of function introduction information according to one or more embodiments. Based on FIG. 14, before the storyboard generation interface is displayed, the function introduction information shown in FIG. 14 may be further displayed. Thus, the storyboard generation interface is displayed in response to a confirmation instruction triggered for a function introduction control based on a control indicated by 1401.

When a video of the long video type is generated, a corresponding account is detected. When a detection result indicates that the corresponding account does not carry a target identifier, it is determined that the corresponding account generates the video of the long video type for the first time, and a target identifier is annotated for the corresponding account after the long video is generated. When the detection result indicates that the corresponding account carries a target identifier, it is determined that the corresponding account does not generate the video of the long video type for the first time. The target identifier is configured for indicating whether the corresponding account generates the video of the long video type for the first time.

In some embodiments, when a user generates the first video of the long video type for the first time, the function of the upward association control is introduced based on the function introduction information, thus lowering a difficulty in using the upward association control. This not only enhances a user experience, but also avoids a case in which the upward association control is mistakenly used and enhances human-computer interaction efficiency.

In some embodiments, each storyboard text may correspond to at least two candidate storyboards. The process of displaying the at least two storyboard texts and the at least two storyboards on the storyboard generation interface may be: displaying the at least two storyboard texts on the storyboard generation interface, and displaying the at least two candidate storyboard texts corresponding to each storyboard text; and for each storyboard text, controlling, in response to a selection operation for a target candidate storyboard among the at least two candidate storyboards, the target candidate storyboard to be in a selected state, and determining the target candidate storyboard that is in the selected state as a storyboard corresponding to the storyboard text.

The candidate storyboards are further associated with preview controls. Thus, in response to a trigger operation for a target preview control among the at least two preview controls, the candidate storyboard corresponding to the target preview control is previewed, and then a selection operation triggered for a target candidate storyboard among the at least two candidate storyboards is received, to select a suitable target candidate storyboard from the at least two candidate storyboards.

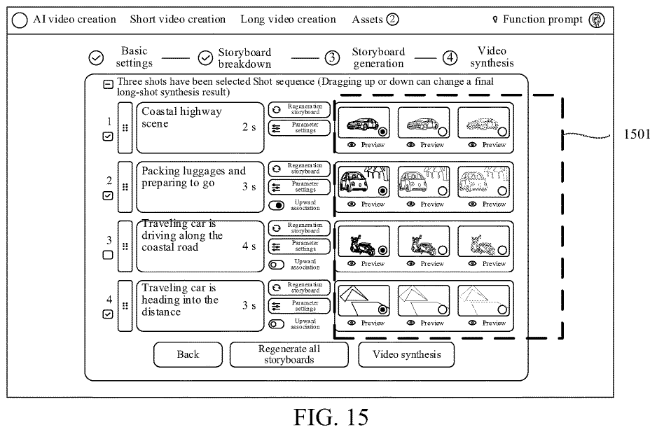

FIG. 15 is a schematic diagram of at least two candidate storyboards according to one or more embodiments. Based on FIG. 15, a dashed box 1501 indicates three candidate storyboards corresponding to each storyboard text. Thus, for each storyboard text, a target candidate storyboard is selected from the three candidate storyboards, to determine at least two storyboards including the target candidate storyboard.

By applying the foregoing embodiment, each storyboard text corresponds to a plurality of candidate storyboards, so that a user can select, from the plurality of candidate storyboards, a storyboard finally corresponding to the storyboard text. In this way, more options are provided for the user. This not only enhances a user experience, but also enables a generated video to better meet user requirements, that is, enhances an effect of the generated video.

In some embodiments, the storyboard texts may be further modified. A modified target storyboard text is displayed in response to a text modification operation for a target storyboard text among the at least two storyboard texts, so that in a subsequent process, a first video of the long video type that includes the modified target storyboard text is displayed in response to the video generation instruction based on the modified target storyboard text.

After the storyboard texts are modified, when a trigger operation is performed on the storyboard update controls corresponding to the corresponding storyboard texts, storyboards generated based on the modified storyboard texts can be displayed. Alternatively, the storyboard generated based on the modified storyboard text may not be displayed. Instead, the first video of the long video type that includes the modified target storyboard text is displayed directly in response to the video generation instruction. As shown in FIG. 13, after the storyboard texts are modified, the foregoing trigger operation for the third confirmation control is directly performed, so as to receive the video generation instruction.

In some embodiments, the storyboard generation interface includes at least one piece of generation prompt information. The generation prompt information and the storyboard texts have a correspondence relationship to indicate whether storyboards corresponding to corresponding storyboard texts are successfully generated. Thus, a first video of the long video type that includes a fourth target storyboard is displayed based on the fourth target storyboard in response to the video generation instruction. The fourth target storyboard is a storyboard whose generation prompt information indicates successful generation.

When at least two candidate storyboards are generated based on a storyboard text, as long as there is a candidate storyboard that is successfully generated, corresponding generation prompt information all indicates that a storyboard corresponding to the storyboard text is successfully generated. Only when all candidate storyboards are unsuccessfully generated, corresponding generation prompt information indicates that the storyboard corresponding to the storyboard text is unsuccessfully generated.

In some embodiments, the target video type is a long video type. A video of the long video type includes a plurality of storyboards. After the inputted target content is displayed in response to the input operation for the content input region, a storyboard generation interface may be directly displayed in response to a confirmation instruction for the inputted target content. The storyboard generation interface includes at least two storyboard texts and at least two storyboards. Each storyboard text corresponds to one storyboard, and the storyboards are generated based on corresponding storyboard texts. Thus, a first video of the long video type that includes the at least two storyboards is displayed in response to the video generation instruction based on the at least two storyboard texts and the at least two storyboards.

Related content on the storyboard generation interface and a related operation performed based on the storyboard generation interface herein are similar to the related content of the displayed storyboard generation interface and the process of performing the related operation based on the displayed storyboard generation interface after the storyboard breakdown interface.

In some embodiments, after a confirmation instruction for target content is triggered, the storyboard generation interface may be directly displayed. Thus, the first video of the long video type that includes the at least two storyboards is generated based on the storyboard generation interface. Compared with a solution in which the storyboard generation interface is displayed after the storyboard breakdown interface is displayed, the solution of generating the first video based on the storyboard generation interface enhances video generation efficiency.

Operation 104: Display, in response to a video generation instruction, a first video of the target video type that is generated based on the target content.

As described above, the video types include long video and short video, so that the generated first video of the target video type may alternatively be a long video or a short video.

In some embodiments, the process of displaying, in response to the video generation instruction, the first video of the target video type that is generated based on the target content may be: displaying, on a video display interface in response to the video generation instruction, the first video of the target video type that is generated based on the target content. The video display interface further includes at least one of the following: detailed information of the generated first video, a third editing control, and a second new video generation control. The third editing control is configured for generating a second video of the target video type again based on the target content. The second new video generation control is configured for re-inputting the target content to the content input region and generating a third video of the target video type based on the re-inputted target content.

A function of the third editing control is similar to the function of the first editing control described above, and a function of the second new video generation control is similar to the function of the first new video generation control described above. The detailed information includes at least one of duration, a size, a content description, prompt information of whether an audio is included, a key image frame, and a resolution of the first video. The key image frame is configured for indicating a cover of the first video, an image inputted when the first video is generated, or the like. The content description is configured for indicating a text inputted when the first video is generated, or configured for indicating text content obtained by analyzing video content of the first video after the first video is generated. Whether an audio is included may indicate whether an audio is inputted when the first video is generated, or may indicate whether an audio is generated when the first video is generated. This embodiment does not impose limitations on this.

By applying the foregoing embodiment, if a user is satisfied with the generated first video based on the detailed information of the first video, a second video associated with the first video may be quickly generated based on the third editing control on the video display interface. In this way, human-computer interaction efficiency is enhanced, and video generation efficiency is also enhanced. Meanwhile, if the user is not satisfied with the first video, a new video can be quickly generated based on the second new video control on the video display interface. Therefore, the human-computer interaction efficiency is enhanced, and the video generation efficiency is also enhanced. In this way, based on the third editing control and the second new video control, the human-computer interaction efficiency and the video generation efficiency are enhanced, and different choices are provided for the user, thereby enhancing a user experience.

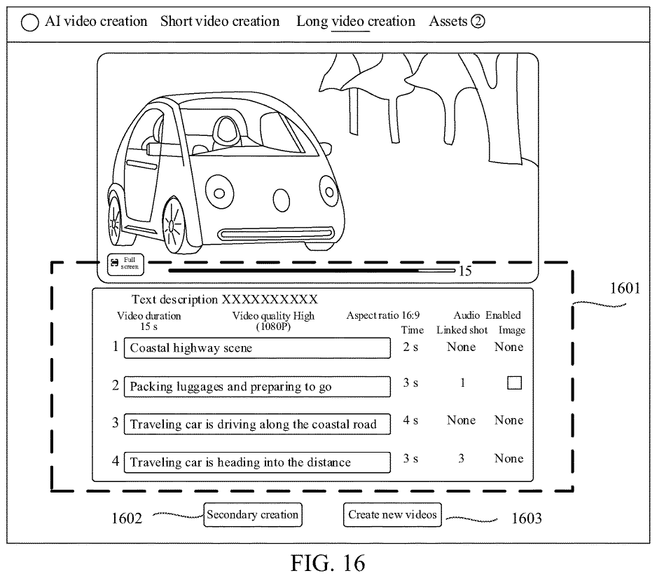

In some embodiments, the video display interface includes a third editing control. The target video type includes long video. The video of the long video type includes at least two storyboards. The detailed information on the details interface further includes duration of each storyboard and a storyboard text corresponding to content of each storyboard. FIG. 16 is a schematic diagram of a video display interface of a long video according to one or more embodiments. Based on FIG. 16, a dashed box 1601 indicates detailed information, 1602 indicates a third editing control, and 1603 indicates a second new video generation control.

In addition, when the target video is a long video, the last interface displayed in response to the trigger operation for the third editing control during the generation of the long video may be the video generation interface, the storyboard breakdown interface (for example, when the target video is generated directly based on the storyboard breakdown interface), or the storyboard generation interface (for example, when the target video is generated directly based on the storyboard generation interface, or when the target video is generated based on the storyboard generation interface after the storyboard generation interface is displayed based on the storyboard breakdown interface).

Based on this, an example in which the last interface displayed during the generation of the long video is the storyboard generation interface is used. As shown in FIG. 13, the target content corresponding to the first video is at least two storyboard texts. The storyboard generation interface further includes at least two storyboards. Each storyboard text corresponds to one storyboard, and the storyboards are generated based on the corresponding storyboard texts. Thus, after the first video of the target video type that is generated based on the target content is displayed on the video display interface in response to the video generation instruction, the storyboard generation interface shown in FIG. 13 may be further displayed in response to the trigger operation for the third editing control; at least two storyboard texts determined based on the target content are displayed, and at least two storyboards determined based on the at least two storyboard texts are displayed; at least two edited storyboard texts and at least two edited storyboards are displayed based on the storyboard generation interface in response to an editing operation for the at least two storyboard texts and the at least two storyboards; and a second video of the long video type that is generated based on the at least two edited storyboard texts and the at least two edited storyboards is displayed in response to the video generation instruction.

Alternatively, an example in which the last interface displayed during the generation of the long video is the storyboard breakdown interface is used. As shown in FIG. 12, the target content corresponding to the first video is at least two storyboard texts. Each storyboard text corresponds to one storyboard, and the storyboard texts are configured for describing the corresponding storyboards. Thus, after the first video of the target video type that is generated based on the target content is displayed on the video display interface in response to the video generation instruction, the storyboard breakdown interface shown in FIG. 12 may be further displayed in response to the trigger operation for the third editing control, and at least two storyboard texts determined based on the target content are displayed on the storyboard breakdown interface; at least two edited storyboard texts are displayed based on the storyboard breakdown interface in response to an editing operation for the at least two storyboard texts; and a second video of the long video type that is generated based on the at least two edited storyboard texts is displayed in response to the video generation instruction.

The editing operation triggered based on the storyboard generation interface may be the aforementioned operation triggered based on various controls such as the update control, the storyboard update control, the arrangement sequence adjustment control, and the parameter setting control on the storyboard generation interface, or may be the editing operation for the storyboard texts. Similarly, the editing operation triggered based on the storyboard breakdown interface may be the aforementioned operation triggered based on various controls such as the arrangement sequence adjustment control and the parameter setting control on the storyboard breakdown interface, or may be the aforementioned editing operation for the storyboard texts. This embodiment does not impose limitations on this.

By applying the foregoing embodiment, when the first video is a long video, if a user is not satisfied with the generated first video, the storyboard generation interface corresponding to the first video can be displayed based on the third editing control. Thus, the at least two storyboards and the at least two storyboard texts that are included in the first video are edited on the storyboard generation interface, and a new first video is generated based on the at least two edited storyboards and the at least two edited storyboard texts. In this way, if the user is not satisfied with the generated first video, the user can modify the first video based on the third editing control, to generate a storyboard that better meets user requirements, thereby not only enhancing an effect of a generated video, but also enhancing human-computer interaction efficiency and increasing a utilization rate of hardware resources of an electronic device.

When the video display interface includes the second new video generation control, and the type of the first video includes long video, if a trigger operation for the second new video generation control is received, the video generation interface shown by b in FIG. 4 is displayed.

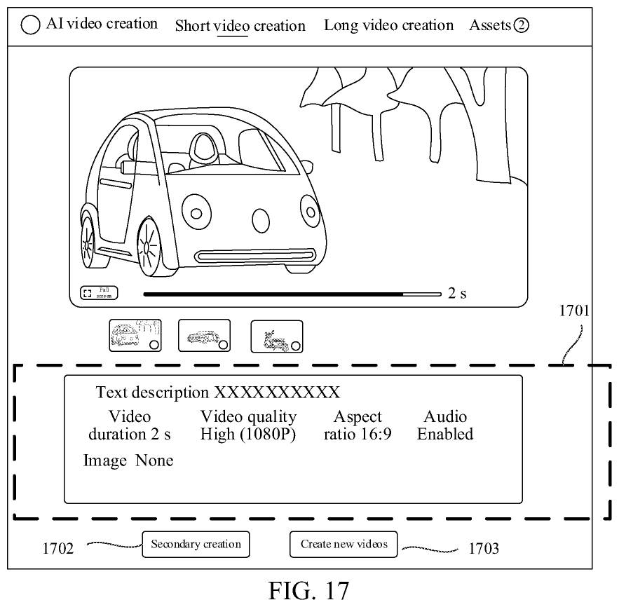

In some other embodiments, the video display interface includes the third editing control, and the type of the first video includes short video. FIG. 17 is a schematic diagram of a video display interface of a short video according to one or more embodiments. Based on FIG. 17, a dashed box 1701 indicates detailed information; 1702 indicates a third editing control; and 1703 indicates a second new video generation control. Meanwhile, as described above, when the first video is a short video, the video generation interface is displayed in response to a trigger operation for the third editing control. After the first video of the target video type that is generated based on the target content is displayed on the video display interface in response to the video generation instruction, the video generation interface including the content input region is displayed in response to a trigger operation for the third editing control, the target content being displayed in the content input region; new target content obtained by editing the target content is displayed in response to an editing operation for the target content; and a second video of the short video type that is generated based on the new target content is displayed in response to the video generation instruction.

The editing operation for the target content in the content input region may be an editing operation for an inputted text, or may be an editing operation for an inputted audio or image, for example, deleting an original audio and/or image, or re-uploading a new audio and/or image. Objects on which the editing operation is performed are different when target content is different.

When the video display interface includes the second new video generation control, and the type of the first video includes short video, if a trigger operation for the second new video generation control is received, the video generation interface shown by b in FIG. 4 is displayed.

In some embodiments, when the first video is a short video, if a user is not satisfied with the generated first video, the video generation interface including the content input region carrying the target content corresponding to the first video may be displayed based on the third editing control. Thus, the target content corresponding to the first video is edited on the video generation interface to generate a new first video based on edited target content. In this way, if the user is not satisfied with the generated first video, the user can modify the first video based on the third editing control, to generate a video that better meets user requirements, thereby not only enhancing an effect of a generated video, but also enhancing human-computer interaction efficiency and increasing a utilization rate of hardware resources of an electronic device.

In some embodiments, the process of displaying, in response to the video generation instruction, the first video of the target video type that is generated based on the target content may be: displaying at least one of first progress prompt information, a fourth editing control, a fourth new video generation control, or a generation cancellation control in response to the video generation instruction, the first progress prompt information being configured for prompting a generation progress of the first video of the target video type, the fourth editing control being configured for regenerating the first video of the target video type based on the target content, the fourth new video generation control being configured for re-inputting the target content to the content input region, and generating the first video of the target video type based on the re-inputted target content, and the generation cancellation control being configured for terminating a generation process of the first video of the target video type; and canceling displaying the first progress prompt information when the first progress prompt information indicates that generation of the first video of the target video type is completed, and displaying the first video of the target video type that is generated based on the target content.

When the first progress prompt information is displayed, it indicates that the first video of the target video type is in a process of being generated. When a generation progress, indicated by the first progress prompt information, of the first video of the target video type is a hundred percent, it indicates that generation of the first video of the target video type is completed. In addition, the fourth editing control is similar to the aforementioned third editing control, and a function of the fourth new video generation control is similar to the function of the aforementioned second new video generation control. Meanwhile, when the first video of the target video type is the long video or the short video, related content when the fourth editing control is triggered is also similar to related content when the third editing control is triggered. Correspondingly, related content when the fourth new video generation control is triggered is also similar to related content when the second new video generation control is triggered.

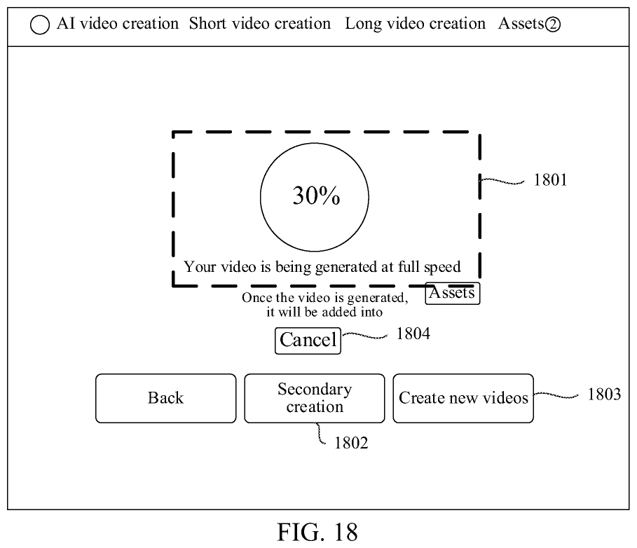

FIG. 18 is a schematic diagram of first progress prompt information according to one or more embodiments. Based on FIG. 18, first progress prompt information indicated by a dashed box 1801, a fourth editing control indicated by 1802, a fourth new video generation control indicated by 1803, and a generation cancellation control indicated by 1804 are displayed in response to the video generation instruction.

In some embodiments, the process of displaying, in response to the video generation instruction, the first video of the target video type that is generated based on the target content may be: displaying at least one of second waiting prompt information, a sixth editing control, a fifth new video generation control, and a waiting cancellation control in response to the video generation instruction, the second waiting prompt information being configured for indicating waiting duration to beginning of generation of the first video, the sixth editing control being configured for regenerating the first video of the target video type based on the target content, the fifth new video generation control being configured for re-inputting the target content to the content input region, and generating the first video of the target video type based on the re-inputted target content, the waiting cancellation control is configured for terminating a waiting process required by the generation of the first video of the target video type; canceling, if the second waiting prompt message is displayed, displaying the second waiting prompt information when the second waiting prompt information indicates that the waiting duration to the beginning of the generation of the first video is zero; and displaying the first video of the target video type that is generated based on the target content.

When the second waiting prompt information is displayed, it indicates that the first video of the target video type is in a process of waiting to be generated, that is, the first video of the target video type has not been generated and is in a queued state. When the second waiting prompt information indicates that the waiting duration to the beginning of the generation of the first video of the target video type is zero, it indicates that waiting for generation by the first video of the target video type ends, that is, there is no video that is being generated ahead and the first video does not need to be queued. In addition, the sixth editing control is similar to the aforementioned third editing control, and a function of the fifth new video generation control is also similar to the function of the aforementioned second new video generation control. Meanwhile, when the target video is the long video or the short video, related content when the sixth editing control is triggered is also similar to related content when the third editing control is triggered. Correspondingly, related content when the fifth new video generation control is triggered is also similar to related content when the second new video generation control is triggered.

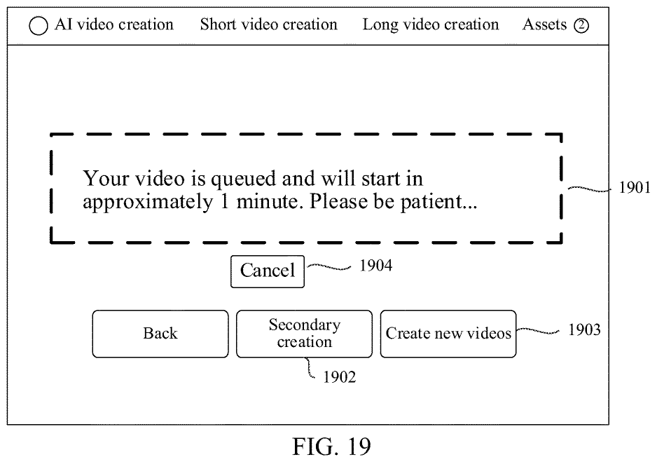

FIG. 19 is a schematic diagram of second waiting prompt information according to one or more embodiments. Based on FIG. 19, second waiting prompt information indicated by a dashed box 1901, a sixth editing control indicated by 1902, a fifth new video generation control indicated by 1903, and a waiting cancellation control indicated by 1904 are displayed in response to the video generation instruction.

In addition to directly displaying the first progress prompt information or the second waiting prompt information, at least one of the second waiting prompt information, the sixth editing control, and the fifth new video generation control may be displayed first. If the second waiting prompt message is displayed, after the displaying of the second waiting prompt information is canceled when the second waiting prompt information indicates that the waiting duration to the beginning of the generation of the first video of the target video type is zero, at least one of the first progress prompt information, the fourth editing control, and the fourth new video generation control is displayed. If the first progress prompt information is displayed, when the first progress prompt information indicates that the generation of the first video is completed, the displaying of the first progress prompt information is canceled, and the first video of the target video type that is generated based on the target content is displayed. This embodiment does not impose limitations on this.

By applying the foregoing embodiment, the second waiting prompt information is displayed to prompt a user of the waiting duration to the beginning of the generation of the first video, thereby improving a user experience.

In some embodiments, after the video generation interface is displayed, video generation prompt information may be further displayed. The video generation prompt information is configured for indicating a quantity of first videos that can be generated within target time. Thus, the process of displaying, in response to the video generation instruction, the first video of the target video type that is generated based on the target content may be: displaying, in response to the video generation instruction when the video generation prompt information indicates that the quantity of first videos that can be generated within the target time is not zero, the first video the target video type that is generated based on the target content.

The target time herein is configured for indicating a target period, and may be set in advance, such as one day or one week. The process of displaying the video generation prompt information may be: directly displaying the video generation prompt information, or may be: displaying the video generation prompt information after the inputted target content is displayed in response to the input operation for the content input region, or may be: displaying the video generation prompt information when the aforementioned trigger operation for the first confirmation control that is in the active state is received. This embodiment does not impose limitations on this.

Meanwhile, the video generation prompt information may be displayed at an associated position of the content input region, such as one of an upper position, a lower position, a left position, and a right position of the content input region, or may be displayed at an associated position of the first confirmation control, such as one of an upper position, a lower position, a left position, and a right position of the first confirmation control.

For example, the video generation prompt information, such as “There are still 10 production tasks remaining today”, indicates that the quantity of first videos that can be generated within the target time, i.e. one day, is 10, or such as “Your daily generation quota has been used up. Please try again tomorrow”, indicates that the quantity of first videos that can be generated within the target time, i.e. one day, is zero. In this way, in response to the video generation instruction, when the video generation prompt information indicates that the quantity of first videos that can be generated within the target time is not zero, the first video of the target video type that is generated based on the target content is displayed.

In some embodiments, the video generation interface further includes a video presentation control. The video presentation control is configured for displaying at least one asset video. The at least one asset video includes at least one of a success video of a historical generation success, a failure video of a historical generation failure, a being-generated video of a being-generated process, and a waiting video of waiting for generation. Thus, after the first video of the target video type that is generated based on the target content is displayed in response to the video generation instruction, at least one asset video including the first video of the target video type is displayed in response to a trigger operation for the video presentation control.

The video presentation control is configured for displaying an asset video presentation interface. The asset video presentation interface further includes at least two video controls, and different video controls are configured for presenting different types of asset videos. In response to a target video control among the at least two video controls being in a selected state, at least one asset video of a target type corresponding to the target video control is displayed.

An arrangement sequence of the success video of the historical generation success, the failure video of the historical generation failure, the being-generated video of the generation process, and the waiting video of waiting for generation among the at least one asset video may be set in advance. For example, the at least one asset video is sequentially presented from top to bottom based on a sequence of the waiting video, the being-generated video, the failure video, and the success video.

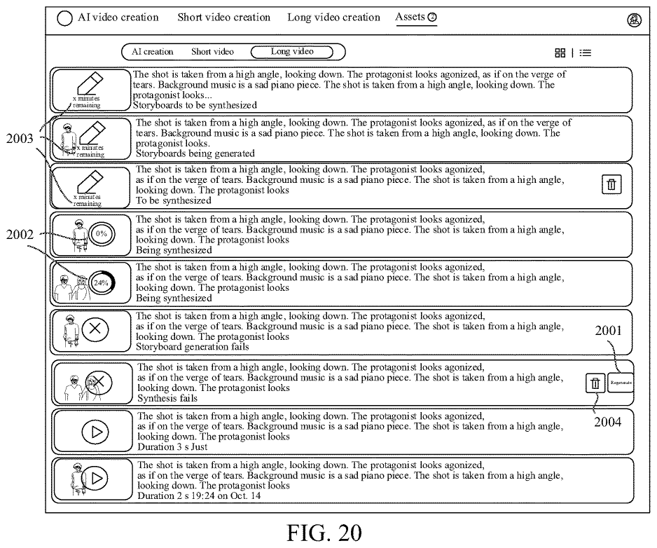

FIG. 20 is a schematic diagram of an asset video presentation interface according to one or more embodiments. Based on FIG. 20, in response to a long video control being in a selected state, nine asset videos of the long video type are displayed. 1^{st}, 2^{nd}, and 3^{rd} asset videos are waiting videos; 4^{th} and 5^{th} asset videos are being-synthesized videos; 6^{th} and 7^{th} asset videos are failure videos; and 8^{th} and 9^{th} asset videos are success videos.

In some embodiments, by displaying the asset video presentation interface including the asset videos, after a video is generated, an editing operation can be performed on the generated video, thereby not only enhancing an effect of the generated video, but also enhancing human-computer interaction efficiency and increasing a utilization rate of hardware resources of an electronic device.

At an associated position of each asset video, at least one of duration, generation time, a content description, and a key image frame of the corresponding asset video may be further displayed. In addition, a refresh control may be further displayed on the asset video presentation interface, to refresh the at least one asset video on the asset video presentation interface in response to a trigger operation for the refresh control.

Next, different asset videos are respectively described.

In some embodiments, the asset videos include the success video. Thus, a playback control corresponding to the success video is displayed; the success video is played back in response to a trigger operation for the playback control; and a details interface of detailed information of the success video is displayed in response to a trigger operation for the success video after playback of the success video is completed. The details interface further includes a fifth editing control and a sixth new video generation control. The fifth editing control is configured for regenerating, based on content of the success video, a video of a video type corresponding to the success video. The sixth new video generation control is configured for re-inputting the target content to the content input region, and generating, based on the re-inputted target content, the video of the video type corresponding to the success video.

When an asset video is a success video, the key image frame is configured for indicating a cover (which may be set in advance for example) of the success video, an image inputted when the success video is generated, or the like. The detailed information includes at least one of duration, a size, a content description, prompt information, a resolution, and a key image frame of the success video. When the success video is a long video including a plurality of storyboards, the detailed information may further include durations of the storyboards and storyboard texts corresponding to content of the storyboards. Meanwhile, a function of the fifth editing control is similar to the function of the aforementioned third editing control, and a function of the sixth new video generation control is also similar to the function of the aforementioned second new video generation control. Meanwhile, when the target video is a long video or a short video, related content when the fifth editing control is triggered is also similar to related content when the third editing control is triggered. Correspondingly, related content when the sixth new video generation control is triggered is also similar to related content when the second new video generation control is triggered

In some embodiments, the asset videos include the failure video. The failure video is associated with a regeneration control. The regeneration control is configured for regenerating a failure video. Thus, after the at least one asset video including the first video is displayed in response to the trigger operation for the video presentation control, a target failure video may be further regenerated in response to a trigger operation for the regeneration control associated with the target failure video among at least one failure video; when the regeneration succeeds, the failure video among the at least one asset video is switched to a regenerated fourth video; and when the regeneration fails, regeneration failure prompt information is displayed. The regeneration failure prompt information is configured for prompting that the regeneration of the failure video fails.

For example, as shown in FIG. 20, in response to a trigger operation indicated by 2001 for a regeneration control associated with a seventh failure video, a corresponding failure video is regenerated; when the regeneration succeeds, the corresponding failure video is switched to a regenerated fourth video; and when the regeneration fails, regeneration failure prompt information is displayed.

By applying the foregoing embodiment, when the asset videos include the failure video of a generation failure, the failure video can be further regenerated based on the regeneration control. In this way, a success rate of video generation is increased, thereby enhancing human-computer interaction efficiency and increasing a utilization rate of hardware resources of an electronic device.

For the failure video, when the failure video is a long video, a reason of the generation failure, such as a storyboard generation failure or a storyboard synthesis failure, may be further displayed at the associated location. Meanwhile, when the regeneration succeeds, a playback control may be further displayed while the failure video is switched to the regenerated fourth video, so that the regenerated fourth video may be played back. Moreover, after the failure video is switched to the regenerated fourth video, the regenerated fourth video may be considered as a success video. Therefore, in response to the trigger operation for the success video, the foregoing related process in which the asset video is the success video is implemented.

In some embodiments, the asset videos include the being-generated video. Thus, second progress prompt information is displayed in the associated region of the being-generated video. The second progress prompt information is configured for prompting a generation progress of the being-generated video, and a generation progress indicated by the progress prompt information increases over time. A generation cancellation control is displayed in response to a trigger operation for the being-generated video. The generation cancellation control is configured for terminating a generation process of the being-generated video.

For example, as shown in FIG. 20, second progress prompt information indicated by 2002 is displayed in the associated regions of 4th and 5th being-generated videos. The second progress prompt information is configured for prompting generation progresses of the being-generated videos.

In response to a trigger operation for the being-generated video, an interface shown in FIG. 18 is further displayed. As described above, the interface includes first progress prompt information indicated by a dashed box 1801, a fourth editing control indicated by 1802, a fourth new video generation control indicated by 1803, and a generation cancellation control indicated by 1804.

In some embodiments, the asset videos include the waiting video. Thus, first waiting prompt information is displayed in the associated region of the waiting video. The first waiting prompt information is configured for indicating that a corresponding waiting video is waiting for being generated. A waiting cancellation control is displayed in response to a trigger operation triggered for the waiting video based on the first waiting prompt information. The waiting cancellation control is configured for terminating a waiting process of the waiting video.

For example, as shown in FIG. 20, first waiting prompt information indicated by 2003 is displayed in the associated regions of 1^{st}, 2^{nd}, and 3^{rd} waiting videos. The first waiting prompt information is configured for indicating that corresponding waiting videos are waiting for being generated.

In some embodiments, displaying the first waiting prompt information prompts a user that the waiting videos are waiting for being generated, thereby improving a user experience. Meanwhile, a waiting process of the waiting videos can be terminated based on the waiting cancellation control. In this way, more options are provided for the user during video generation, thereby further enhancing the user experience, and the waiting process of the videos can be terminated in time when the user does not intend to wait for video generation, thereby avoiding a waste of computer resources.

For the waiting video, when the waiting video is a long video, waiting progress information may be further displayed in an associated position, such as a storyboard being to be generated, or a storyboard being generated, or being to be synthesized.

When the waiting process information indicates that the corresponding waiting video is in a state of a storyboard being to be generated, the aforementioned storyboard breakdown interface or video generation interface is displayed in response to a trigger operation for the waiting video. When the waiting process information indicates that the corresponding waiting video is in a state of a storyboard being generated, the aforementioned storyboard generation interface is displayed in response to a trigger operation for the waiting video. When the waiting process information indicates that the corresponding waiting video is in a state of being to be synthesized, the interface shown in FIG. 19 is displayed in response to a trigger operation for the waiting video. As described above, the interface includes the second waiting prompt information indicated by the dashed box 1901, the sixth editing control indicated by 1902, the fifth new video generation control indicated by 1903, and the waiting cancellation control indicated by 1904.

In some embodiments, the asset videos are further associated with deletion controls. Thus, in response to a trigger operation for the deletion control corresponding to the target asset video among the at least one asset video, deletion prompt information is displayed. The deletion prompt information configured for determining whether to delete the target asset video. In response to a confirmation instruction triggered based on the deletion prompt information, the target asset video is deleted.

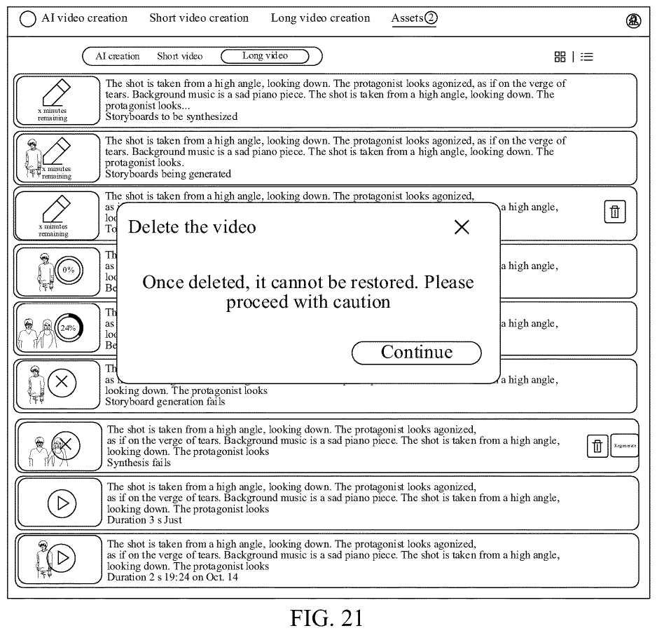

FIG. 21 is a schematic diagram of deletion prompt information according to one or more embodiments. Based on FIG. 20, deletion prompt information indicated in FIG. 21 is displayed in response to a trigger operation for a deletion control that is associated with a 7^{th} failure video and is indicated by 2004. Thus, in response to a confirmation instruction triggered based on the deletion prompt information, the target asset video is deleted.

In some embodiments, after the inputted target content is displayed in response to the content input operation performed in the content input region, in response to the video generation instruction, at least one of generation failure prompt information, a regeneration control, and a backtracking control may be further displayed when generation of the first video of the target video type fails. The generation failure prompt information is configured for indicating a generation failure of the first video of the target video type and a reason of the generation failure. The regeneration control is configured for regenerating the first video of the target video type, and the backtracking control is configured for returning to the previous operation.

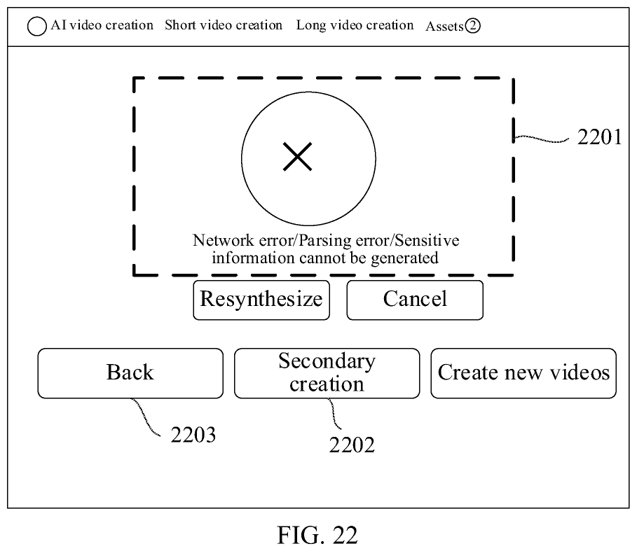

FIG. 22 is a schematic diagram of generation failure prompt information, a regeneration control, and a backtracking control according to one or more embodiments. Based on FIG. 22, a dashed box 2201 indicates the generation failure prompt information, 2202 indicates the regeneration control, and 2203 indicates the backtracking control.

The storyboard breakdown interface, the storyboard generation interface, and the interface for displaying the second waiting prompt information and displaying the first progress prompt information may all include the backtracking control. Thus, the previous operation is returned based on the backtracking control. However, after the backtracking control displayed on the interface for displaying the generation failure prompt information is triggered, content in the returned previous operation may be modified. For example, when generation of a long video fails, the storyboard breakdown interface or the storyboard generation interface is displayed in response to the trigger operation for the backtracking control. In this case, a storyboard text and/or a storyboard may be modified based on the corresponding storyboard breakdown interface or the corresponding storyboard generation interface. Thus, the long video is regenerated based on a modified storyboard text and/or storyboard.

However, for a case in which the generation does not fail, after the backtracking control displayed on a corresponding interface is triggered and displayed, the content in the returned previous operation cannot be modified. For example, the backtracking control is displayed on the interface for displaying the second waiting prompt information, and the interface in the previous operation is displayed in response to the trigger operation for the backtracking control, but the content on the interface cannot be modified.

In some embodiments, the video generation interface further includes a style setting control. The style setting control is configured for setting a video style of the generated first video. After the at least one video generation control is displayed on the video generation interface, at least one video style is displayed in response to a trigger operation for the style setting control; and the target video style is controlled to be in a selected state in response to a selection operation for a target video style among the at least one video style. Thus, the process of displaying, in response to the video generation instruction, the first video of the target video type that is generated based on the target content may be: displaying, in response to the video generation instruction, a first video of the target video type that is generated based on the target content and has the target video style.

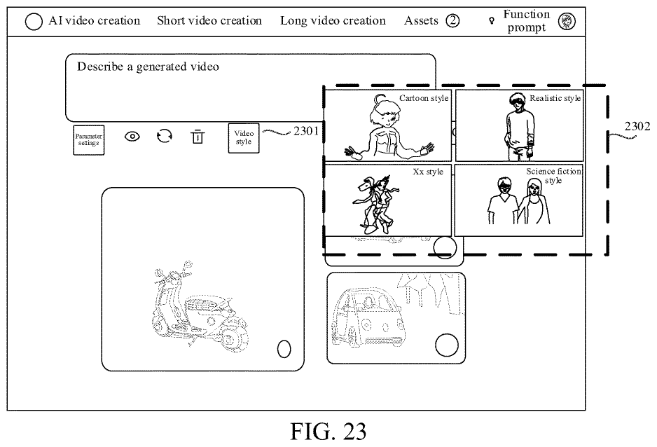

The video style herein may be a cartoon style, a science fiction style, a realistic style, or the like. FIG. 23 is a schematic diagram of at least one video style according to one or more embodiments. Based on FIG. 23, in response to a trigger operation for a style setting control indicated by 2301, at least one video style indicated by a dashed box 2302 is displayed. Thus, in response to a selection operation for a target video style among the at least one video style, the target video style is controlled to be in a selected state, to generate a first video of the target video type that has the target video style.

By applying the foregoing embodiment, the video style of the generated first video may be set through the style setting control, thereby not only enriching diversity of the first video, but also enhancing a video effect of the first video, enhancing human-computer interaction efficiency, and increasing a utilization rate of hardware resources of an electronic device.

In some embodiments, after the target video style is controlled to be in the selected state in response to the selection operation for the target video style among the at least one video style, an identifier of the target video style is displayed on the style setting control in response to a confirmation instruction for the target video style that is in the selected state, the identifier being associated with a style cancellation control; the identifier of the target video style being configured for identifying that the generated first video of the target video type has the target video style; and the identifier of the target video style is canceled being displayed on the style setting control in response to a trigger operation for the style cancellation control. Thus, the process of displaying, in response to the video generation instruction, the first video of the target video type that is generated based on the target content and has the target video style may be: displaying, in response to the video generation instruction, a first video of the target video type that is generated based on the target content and has a default video style.

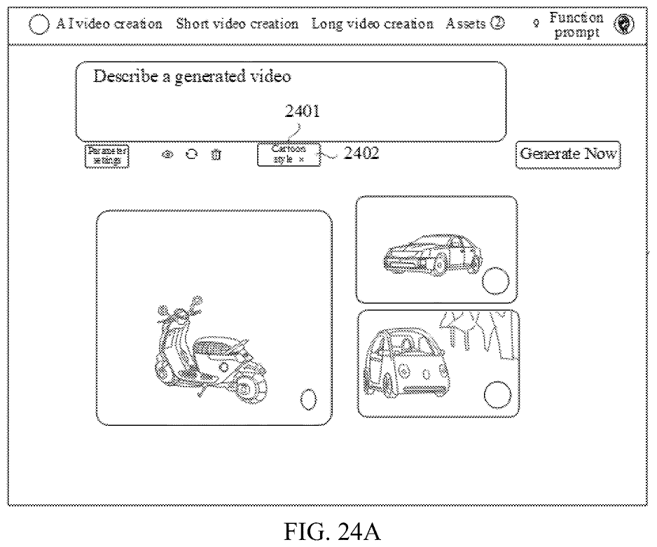

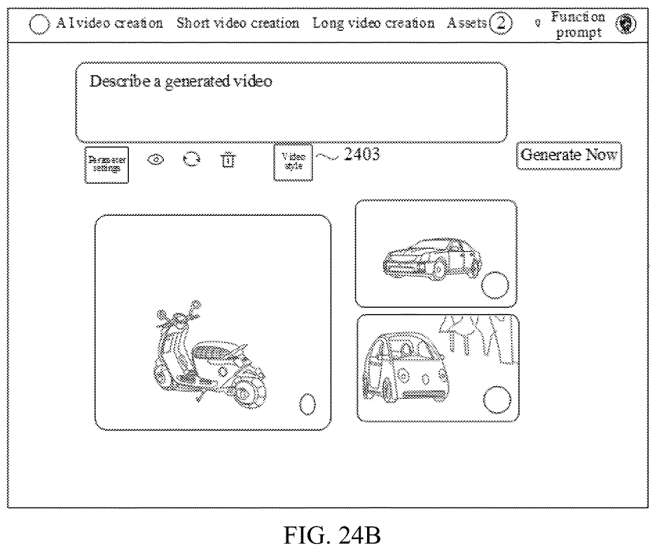

The identifier of the target video style may refer to a name of the target video style. After the identifier of the target video style is canceled being displayed on the style setting control, an original video style control may be displayed, so that if the video generation instruction is received at this time, a video of the target video type that has the default style may be generated. FIGS. 24A and 24B are schematic diagrams of an identifier of a target video style according to one or more embodiments. In FIG. 24A, in response to a confirmation instruction for the target video style that is in the selected state, the identifier, i.e. a cartoon style, of the target video style is displayed on a style setting control indicated by 2401, where 2402 indicates a style cancellation control associated with the identifier. Thus, in response to a trigger operation for the style cancellation control, the identifier of the target video style is canceled being displayed on the style setting control, and an original video style control indicated by 2403 in FIG. 24B is displayed. Therefore, the first video of the target video type that is generated based on the target content and has the default style is displayed in response to the video generation instruction based on the original video style control.

In some embodiments, a video style that has been selected by a user may be canceled through the style cancellation control. This avoids a case in which the user mistakenly selects a video style, thereby enhancing an error-tolerant rate in a video generation process. In this way, this not only enhances a user experience, but also enhances human-computer interaction efficiency and a video generation effect.

In some embodiments, when a plurality of first videos of the target video type are generated, the process of displaying the first videos of the target video type that are generated based on the target content is: sequentially automatically playing back the first videos of the target video type until a last first video of the target video type is played back.

In some embodiments, after the first video of the target video type that is generated based on the target content is displayed in response to the video generation instruction, an operation control for a target video may be further displayed. The operation control includes at least one of the following: a like control configured for liking the first video, a share control configured for sharing the first video, a download control configured for downloading the first video, a dislike control configured for disliking the first video, a playback control configured for playing the first video, and a full-screen control configured for performing full-screen displaying on the first video. In response to a trigger operation for a target operation control, an operation indicated by the target operation control is performed for the first video. The target operation control is one of the like control, the share control, the download control, the dislike control, the playback control, and the full-screen control.

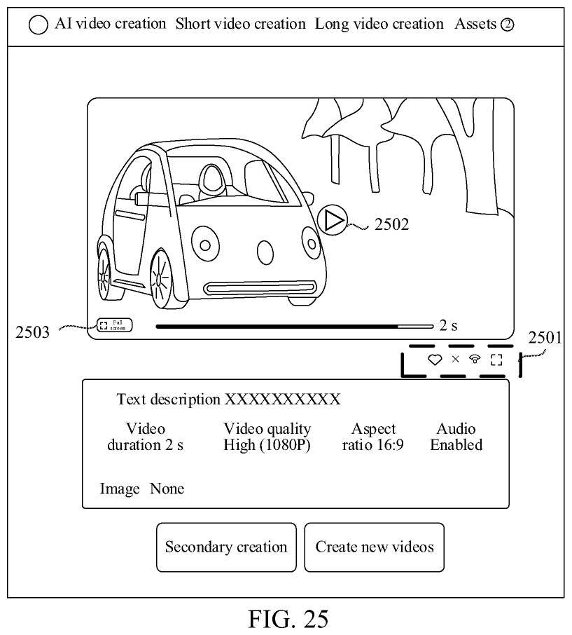

FIG. 25 is a schematic diagram of operation controls according to one or more embodiments. Based on FIG. 25, a dashed box 2501 respectively indicates a like control, a dislike control, a share control, and a download control, 2502 indicates a playback control, and 2503 indicates a full-screen control.

In some embodiments, after the first video of the target video type that is generated based on the target content is displayed in response to the video generation instruction, at least one interaction control for the first video may be further displayed, the interaction control being one of the following controls: a local editing control configured for locally editing the first video, a canvas extension control configured for editing a size of the first video, a moving brush control configured for turning a static object in the first video into a dynamic object, a camera movement parameter setting control configured for setting a camera movement parameter of the first video, a background removal control configured for removing a background of the first video, an object erase control configured for erasing a target object from the first video, a scene detection control configured for segmenting the video into different video clips based on different scenes in the first video, a depth-of-field control configured for setting a depth-of-field effect for the first video, a frame rate adjustment control configured for adjusting a frame rate of a storyboard in the first video, an action sequence generation control configured for setting an action sequence for an object in the first video, and a third new video generation control configured for generating a new video based on audio data in the first video; and an interaction operation indicated by the target interaction control is performed on the generated first video of the target video type in response to a trigger operation for a target interaction control among the at least one interaction control.

In some embodiments, when the target interaction control is the local editing control, a local editing box and a text input box are displayed in response to a trigger operation for the local editing control. The inputted text content is displayed in response to an input operation based on the text input box. The text content is configured for describing an editing task. A locally edited fifth video is displayed in response to a video editing instruction. The fifth video is a video obtained by editing, based on the text content, a region indicated by the local editing box in the first video.

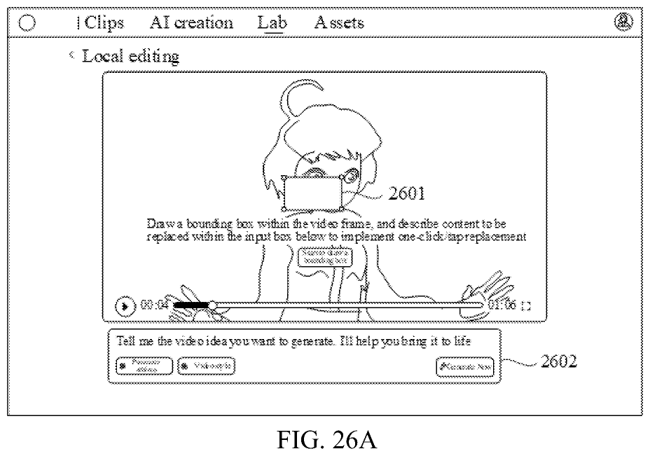

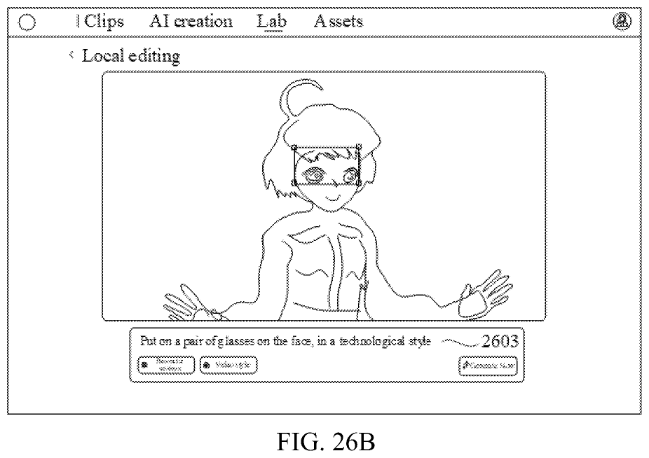

FIGS. 26A and 26B are schematic diagrams of interaction of a first video based on a local editing control according to one or more embodiments. Based on FIG. 26A-B, when the target interaction control is the local editing control, in response to a trigger operation for the local editing control, a local editing box indicated by 2601 in FIG. 26A and a text input box indicated by 2602 are displayed, and inputted text content indicated by 2603 in FIG. 26B is displayed in response to an input operation based on the text input box. Thus, the locally edited fifth video is displayed in response to the video editing instruction.

When the local editing box is displayed, a size of the local editing box may be further adjusted. Meanwhile, an editing take-effect time period may be further set. After a local input box is displayed, a forward time input box and a backward time input box are displayed. After a user inputs a target time period to the forward time input box, by default, a video within a forward target time period has an editing effect from time corresponding to an image frame at which the local editing box is located. After the user inputs the target time period to the backward time input box, by default, a video within a backward target time period has an editing effect from time corresponding to an image frame at which the local editing box is located. When no content is inputted to the forward time input box and the backward time input box, by default, all videos have editing effects.

The inputted text content may be: adding a target object into the local editing box, erasing an object from the local input box, or the like.

In some embodiments, when the target interaction control is a canvas extension control, a canvas with at least one size is displayed in response to a trigger operation for the canvas extension control. The first video is displayed on a canvas with a target size in response to a selection operation for the canvas with the target size. Thus, a sixth video is displayed on the canvas with the target size in response to a size adjustment operation for the first video. The sixth video is a size-adjusted first video, and a size of the sixth video is not greater than a size of the first video. In this way, convenience of adjusting the size of the first video is enhanced based on the canvas extension control.

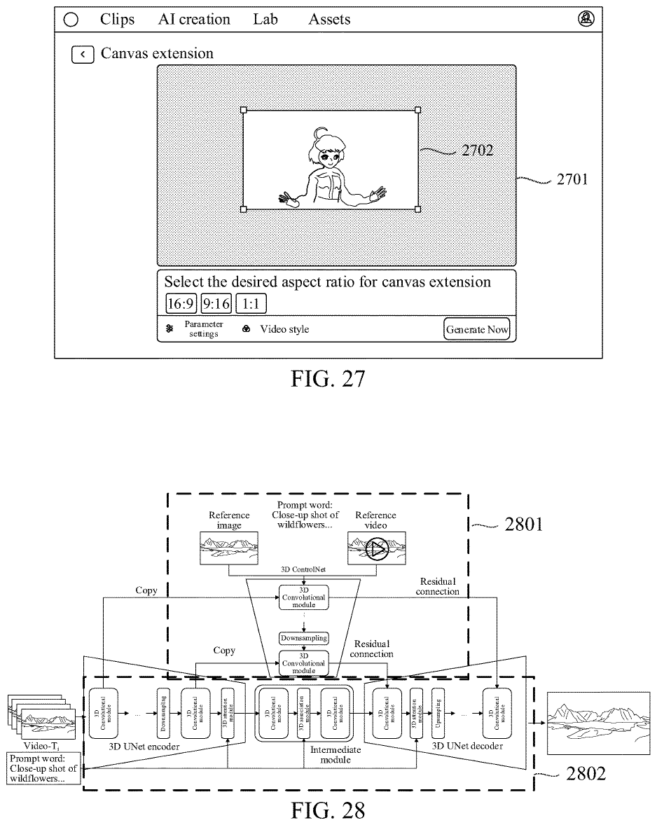

FIG. 27 is a schematic diagram of performing interaction on a first video based on a canvas extension control according to one or more embodiments. Based on FIG. 27, when the target interaction control is the canvas extension control, a sixth video indicated by 2702 is displayed on a canvas 2701 with a target size in response to a selection operation for the canvas with the target size.

In some embodiments, when the target interaction control is an action sequence generation control, at least one candidate action sequence is displayed in response to a trigger operation for the action sequence generation control. A target candidate action sequence that is in a selected state is displayed in response to a trigger operation for a target candidate action sequence among the at least one candidate action sequence. Then, a seventh video is displayed in response to the video editing instruction. The seventh video is a video obtained by setting an object in the first video to be the target candidate action sequence.

An action sequence is configured for indicating a continuous action video, for example, a dance video. Setting the object in the first video to be the target candidate action sequence means that the corresponding object is controlled to perform an action indicated by the target candidate action sequence. For example, the corresponding object is enabled to dance with a dance action indicated by the dance video.

When the at least one candidate action sequence is displayed, the text input box is further displayed. Thus, the inputted text content is displayed in response to the input operation based on the text input box. The text content is configured for describing an editing task. Thus, the seventh video obtained by setting the object in the first video to be the target candidate action sequence determined based on the text content is displayed in response to the video editing instruction.

In some embodiments, when the target interaction control is the moving brush control, the brush control is displayed in response to a trigger operation for the moving brush control. The brush control may move on an image frame of the first video to select a target object that is in a static state in a corresponding image frame, to change a state of the selected target object from the static state to a dynamic state. The selected target object that is in the static state is displayed at the corresponding image frame in response to a selection operation triggered based on the brush control. The state of the selected target object is changed from the static state to the dynamic state in response to a confirmation instruction for the target object. An eighth video is displayed in response to the video editing instruction. The eighth video is a video obtained by changing the state of the target object in the first video from the static state to the dynamic state.

In some embodiments, when the target interaction control is the camera movement parameter setting control, a camera movement parameter setting region is displayed in response to a trigger operation for the camera movement parameter setting control, the parameter setting region being configured for setting a camera movement parameter of the first video; the camera movement parameter set for the first video is displayed based on the camera movement parameter setting region in response to a camera movement parameter setting operation, the camera movement parameter including a motion direction, a motion speed, and the like of a camera; and a video obtained by performing parameter adjustment on the first video based on the set camera movement parameter in response to a confirmation instruction for the camera movement parameter.

In some embodiments, when the target interaction control is the background removal control, a background of the first video is removed in response to a trigger operation for the background removal control, to obtain a ninth video. The background of the first video may be, for example, a sky or a mountain.

In some embodiments, when the target interaction control is the object erase control, an erase tool that is in a draggable state is displayed in response to a trigger operation for the object erase control. The erase tool may move on an image frame of the first video, to select a target object included in a corresponding image frame, to delete the selected target object; the selected target object is displayed on the corresponding image frame in response to a selection operation triggered based on the erase tool; the selected target object is deleted in response to a confirmation instruction for the target object; and a first video from which the target object is deleted is displayed in response to the video editing instruction.

In some embodiments, when the target interaction control is the scene detection control, in response to a trigger operation for the scene detection control, the first video is split into at least one video clip based on at least one scene included in the first video. Video clips correspond to one scene.

In some embodiments, when the target interaction control is the depth-of-field setting control, a set target depth-of-field parameter is displayed in response to a depth-of-field setting operation triggered based on the depth-of-field setting control. Thus, a first video having the target depth-of-field parameter is displayed in response to a confirmation instruction for the set target depth-of-field parameter. That is, a video obtained by performing parameter adjustment on the first video based on the set target depth-of-field parameter is displayed.

In some embodiments, when the target interaction control is the frame rate adjustment control, an adjusted target frame rate is displayed in response to a frame rate adjustment operation triggered based on the frame rate adjustment control. Thus, a first video having the target frame rate is displayed in response to a confirmation instruction for the adjusted target frame rate. That is, a video obtained by performing frame rate adjustment on the first video based on the adjusted target frame rate is displayed.

In some embodiments, when the target interaction control is the third new video generation control, a tenth video is generated based on audio data of the first video in response to a trigger operation for the third new video generation control. Content of the tenth video is associated with the audio data.

In addition to performing interaction based on the first video, another video or audio may be selected for interaction. That is, at least one interaction control is displayed. At least one candidate video is displayed in response to a trigger operation for a target interaction control among the at least one interaction control; in response to a selection operation for a target candidate video among the at least one candidate video, the target candidate video is controlled to be in a selected state; and in response to a confirmation instruction for the target candidate video that is in the selected state, performing an interaction operation indicated by the target interaction control on the target candidate video. When the target interaction control is the third new video generation control, the at least one candidate video further includes an audio. Thus, in response to a confirmation instruction for a target audio or the target candidate video that is in the selected state, a video generated based on the target audio or audio data of the target candidate video is displayed.

In some embodiments, an interaction operation for a video may be triggered not only through a control, but also through a text input box. As described above, when the target interaction control is the local editing control, the local editing box and the text input box may be displayed in response to the trigger operation for the local editing control, or the text input box may be displayed when the at least one interaction control for the first video is displayed. Thus, the inputted text content is displayed in response to the input operation based on the text input box. The text content is configured for describing an editing task. In response to the video editing instruction, a video obtained by performing interaction on the first video based on at least one of the text content and the interaction control. For example, content such as “Warm the image” may be inputted to the text input box, so as to change an image filter effect of the first video, or content such as “Delete the object XX” may be inputted, so as to delete the object XX from the first video.

In some embodiments, different interaction operations can be performed on the generated first video based on different interaction controls, thereby not only optimizing an effect of the generated video, but also enhancing human-computer interaction efficiency and increasing a utilization rate of hardware resources of an electronic device.

By applying one or more embodiments of the disclosure, first, the at least one video generation control configured for generating the videos of the different video types is displayed. Then, the content input region corresponding to the target video type is displayed based on the at least one video generation control in response to the target video type among the at least two video types being in the selected state, and the target content is inputted based on the content input region, thus generating the first video of the target video type based on the inputted target content. In this way, the video of the target video type that corresponds to the target content is generated based on the target content inputted by a user, so that the video content of the target video meets user requirements. Furthermore, the video of the target video type is generated based on the video generation control, so that the video type also meets the user requirements. Compared with a solution in which the user needs to clip a video to generate a final video, one or more embodiments of the disclosure enhances video generation efficiency, thereby not only enhancing human-computer interaction efficiency, but also increasing a utilization rate of hardware resources of an electronic device.

The following describes exemplary application of this embodiment in an actual application scene.

There are many types of videos, for example, short videos and long videos. Different types of videos correspond to different video parameters and different video generation processes. However, in the related art, videos are mostly generated directly based on requirements of users for video content. That is, the requirements of the users for the video content are only considered, and requirements of the users for video types are ignored. In this way, after a video is generated, a user further needs to clip the video, so that a clipped video meets the requirements of the users for the video types while meeting the requirements of the users for the video content. This not only excessively reduces the human-computer interaction efficiency, but also further reduces the video generation efficiency.

Based on this, one or more embodiments provides a video generation method. In one aspect, this method comprehensively combines a multi-modality capability, and supports capabilities such as image to video, image-text to video, video to video, and image+video to video in addition to supporting only text to video. In another aspect, by combining the capability of splitting a text to generate a storyboard subscript with the capability of generating and stitching a short video, a short video of 2 to 4 s can be generated by inputting a text, or after a text is inputted (herein, after the text is subsequently modified, a storyboard can change with the modified text), a model automatically splits the text into a plurality of storyboard subscripts. The plurality of storyboard subscripts support editing behaviors such as addition and deletion, and also support customized selection of correlation between different storyboards, to further support generation of a long video with longer time, present intermediate operations and information in a long video generation process, and support adjustment performed by a user at any time. In addition, functions of different higher-order playing methods may alternatively be executed by means of a laboratory lab (extended editing), to support functions such as video mask selection and editing, canvas extension, and video generation by using skeleton points.

Next, the technical solutions of the disclosure are described from a product side. The product side of the technical solutions of the disclosure includes two parts. A first part is creation of a video, and a second part is interactive editing of the video. A process of creating a video is further divided into two processes, namely, a process of creating a short video and a process of creating a long video.

For the process of creating a short video, as shown in FIG. 4, a goodcase (a video template) is presented below the input box in a waterfall flow form, including a video and a text. When a target video template is a selected state, a content description of the target video template and a corresponding secondary creation button (the first editing control) are presented. Then, after a click/tap operation for the secondary creation button is received, the content description of the target video template is filled into the input box.

In some embodiments, in response to an input operation of a user, an immediate generation control (the first confirmation control) in FIG. 4 is controlled to switch from an inactive state to an active state. The input operation may be at least one of inputting at least one of a text, an image, and an audio. Herein, when an image is inputted, the image is used as a reference image of a video, and it only supports uploading a single image and supports re-uploading, image review, and image deletion.

The parameter setting region shown in FIG. 11 may be further displayed in response to a trigger operation performed by the user on the parameter setting control shown in FIG. 4. Thus, a parameter of the video is set in response to a parameter setting operation triggered based on the parameter setting region. If the user does not perform a parameter setting operation, a default parameter configuration is used. For example, by default, there is no image, there is no effect, the video quality is 896*512, the ratio is 7:4, the video duration is 4 s, and there is no audio.

In some embodiments, in response to the input operation of the user, the immediate generation control is controlled to switch from the inactive state to the active state, and in response to the parameter setting operation triggered based on the parameter setting region, after the parameter of the video is set, when the trigger operation for the immediate generation control that is in the active state is received, the first waiting prompt information shown in FIG. 19 is displayed. The first waiting prompt information is configured for indicating that a to-be-created short video is in a queued state. This state is a queuing state before generation starts after the immediate generation control is clicked/tapped, and a corresponding state is waiting in the like. In addition, estimated remaining tasks may be further presented.

In some embodiments, after the queuing state ends, the first progress prompt information shown in FIG. 18 is displayed. The first progress prompt information is configured for indicating that the to-be-created short video is in a being-generated state. This state is a state of a generation process from the beginning of the generation to returning of a result, and a video generation progress may be further presented.

In an intermediate state, i.e. the queuing state, and the being-generated state, an interface modification operation, including a text, an image, and a parameter configuration, is not allowed. However, the user is allowed to create a new video. For example, when a new short video is created, the interface shown by FIG. 8B is displayed in response to a click/tap operation for the secondary creation control or the new video creation control shown in FIG. 18 or FIG. 19, for example, in response to a click/tap operation for the secondary creation control, and inputted content corresponding to the to-be-created video is filled into the input box as new inputted content, so as to generate, based on the new inputted content, a video associated with the to-be-created video. In response to a click/tap operation for the new video creation control, the interface shown by FIG. 8A is displayed. The input box (the content input region) on the interface is blank, so that the user re-inputs new content to generate a video based on the inputted new content. When the click/tap operation for the secondary creation control or the new video creation control shown in FIG. 18 or FIG. 19 is received, a task that is currently being in progress is received to assets.

In some embodiments, in a video generation process, three videos are generated each time. One of the three videos is supported to be selected and previewed in a main window. In addition, a like operation, a dislike operation, a share operation, and a download operation may be alternatively performed on the generated videos.

When generation of all videos fails, the generation failure interface shown in FIG. 22 is presented. The generation failure interface includes the regeneration control used for regeneration. After the user clicks/taps the regeneration control, a video is regenerated. Moreover, a video that fails in generation is also saved as an asset. When generation of some videos fails, a video that succeeds in generation is normally returned, and a generation failure is presented at a front end of a video that fails in generation. For some videos that fail in generation, since the video that succeeds in generation exists, this asset is considered as being successfully generated and does not support regeneration. That is, as long as one video is successfully generated, this asset is considered as being successfully generated.

In some embodiments, a video style may be further set. As shown in FIG. 23, the style setting control is displayed. At least one selectable video style is presented in response to a trigger operation for the style setting control, and a video corresponding to a target video style is generated in response to a selection operation for the target video style among the at least one selectable video style.

For the process of creating a long video, a long video needs to be generated in stages. The process specifically includes four stages. Next, the four stages are respectively described.

### 1) Stage I: Input Content and Configure Global Parameters.

As shown in c and d in FIG. 10, when no input operation of a user is received, a next operation cannot be executed by clicking/tapping. That is, a button for next operation is gray (in an inactive state). When an input operation of the user is received, the button for next operation may be clickable/tappable (in an active state). The input operation may be inputting at least one of a text, an image, and an audio.

In some embodiments, the parameter configuration region shown in FIG. 11 may be further displayed. Thus, a parameter of the video is set in response to a parameter setting operation triggered based on the parameter setting region. If the user does not perform a parameter setting operation, a default parameter configuration is used. For example, video duration is 6 s by default, the video quality is 896*512 by default, the radio is 7:4 by default, and there is no audio by default.

### 2) Stage II: Generate a Segmented Storyboard Description to Allow the User to Perform Secondary Editing.

In some embodiments, as shown in FIG. 12, a storyboard description is generated (the storyboard breakdown interface is displayed), including a description corresponding to this video segment and a correspondingly set parameter. Each description supports re-editing, that is, text editing, parameter setting adjustment (adding an effect), adding a reference image (a key image frame), and the like. For storyboards, it supports adjustment of a sequence by the user. In addition, the user may further customize a newly-added storyboard and a corresponding text. After a storyboard is added, a storyboard script may be automatically generated, or may be customized and inputted. Finally, after the adjustment is completed, the storyboard generation interface is displayed in response to a click/tap operation for a generation control (the second confirmation control).

In a case of a storyboard generation failure, when generation of all storyboards fails, a generation failure message (the generation failure prompt information) is presented, and regeneration of a video is supported.

### 3) Stage III: Generate a Storyboard.

In some embodiments, as shown in FIG. 13, a storyboard shot is generated (the storyboard generation interface is displayed). Each shot includes a storyboard text description, a parameter configuration, and three correspondingly generated storyboard videos (candidate storyboards). Each storyboard supports secondary editing, that is, text editing, parameter setting adjustment, addition of a reference image (a key image frame), and supporting of selection of whether a storyboard of a next level is associated with a previous level. The parameter setting adjustment includes adjusting an effect and uploading an image, and adjustment of a storyboard sequence is supported between different storyboards. Meanwhile, after adjustment, regeneration of corresponding storyboards is supported.

For a process in which the user selects a storyboard (supports multi-selection) and a specific video (single selection) in a corresponding storyboard, all storyboards are selected by default. A first video is selected in each storyboard. If no storyboard is selected, a button (the third confirmation control) for synthesizing a video cannot be clicked/tapped. In addition, one-click/tap regeneration of all storyboards is supported. The user may further upload an existing short video, and generate a video (the first video of the target video type) together with the storyboards on the interface.

In some embodiments, when some storyboards are successfully generated, the successfully generated storyboards are normally returned, and a storyboard that fails in generation is presented at the front end. The generation of a storyboard is considered to succeed as long as one or more candidate storyboards are successfully generated in the corresponding storyboard text.

### 4) Stage IV: Synthesize a Long Video.

In some embodiments, in response to a click/tap operation performed by the user on a video synthesis control (the third confirmation control), the storyboards selected by the user, sequence information, and associated information are transmitted to a backend for video synthesis. In addition, a case of the waiting state and a case of a generation failure are the same as those in the process of generating a short video. In addition, a generated video may be liked, disliked, shared, or downloaded.

### 5) Support Returning to View Information (Based on the Backtracking Control) in the Completed Preceding Stages, and Support No Editing.

If there is overlapping information in stage II and stage III, which is modified in stage III but is not triggered to be regenerated, the information is not synchronized in stage II; and if the information is triggered to be regenerated, the information is synchronized to stage II.

Interactive editing of a video includes, but is not limited to, video supporting style conversion and regeneration (the style setting control), video canvas extension (the canvas extension control), in-video element addition, deletion, and modification (the local editing control), for example, adding a specific body by circling a specific region and editing a clue, a moving brush, camera movement parameter setting, prolonging of video generation duration, video generation by using a plurality of images, and video generation by skeleton point driving (the action sequence generation control), video generation by using videos, for example, generating a new video through three modes (i.e. video+image, video+style selection, and video+text), a story version function (for example, after generation of a video is completed, a new scene may be selected to be added to refill a prompt word. A new plot may be added to the entire video, and each plot may be individually set. The newly added scene does not support re-uploading of an image, or a scene may be deleted), a video editing tool (the background removal control), an object erase tool (the object erase control), color grading (this function can easily process a video image filter effect by inputting only a descriptive text), an ultra-slow action tool (the frame rate adjustment control. This function can reduce a frame rate of video shots to convert the video shots into a smooth slow action video), and a video depth-of-field tool (the depth-of-field setting control. This function can automatically process a video into an image having a depth-of-field effect), scene detection (the scene detection control. This function can automatically segment a shot of a video uploaded into a plurality of segments), and video generation by using audios (the third new video generation control).

In some embodiments, videos on which interactive editing is performed are all saved into a uniform asset page, and a function source of each video is identified. Quick jump is supported from a tab of each function. Assets of own functions are saved in each function. Meanwhile, a quick entry for advanced editing is added for assets that are successfully generated in the asset page, and an interactive editing function interface may be directly displayed by clicking/tapping the quick entry (that is, the operation of uploading a video is skipped).

In some embodiments, the interactive editing process specifically includes video selection/uploading, editing, generation, and asset storage. The process of uploading a video supports pulling of video assets and local uploading, and supports single selection. Existing assets are pulled to indicate to present all videos that are successfully generated in the asset page, to support selection of a user. However, local uploading indicates that locally uploading a video is supported. Duration clipping is supported after uploading. Duration clipped can only be an integer of 2, 3, and 4 seconds, and non-integer duration such as 2.5 seconds cannot be customized for clipping.

In some embodiments, for functions in the interactive editing, all input sources are videos. After a video is uploaded, interactive editing is performed on the inputted video based on an interactive editing function interface. For a local editing process of a video, as shown in FIG. 26, in a video playback process, a user is supported to perform box selection on a desired region. During box selection, the video is automatically paused. Then, after the box selection is completed, a prompt word editing box (the text input box) and a selector pop up. The editing box supports filling of a prompt word, and the selector supports selection of taking effect forward, taking effect backward, and taking effect to all. If the selection is not performed, taking effect to all is selected by default. Taking effect forward indicates that a video from the beginning of the video to current time includes a prompt word change effect. Taking effect backward indicates that a video from current time to the end of the video includes a prompt word change effect. Taking effect to all indicates that an entire video includes a prompt word change effect. Then, conventional parameter setting is performed, for example, supporting setting of an effect, video quality, a sound effect, and a style. A setting logic employs the video generation process.

For a canvas extension process, as shown in FIG. 27, after a video is uploaded, an extension aspect ratio can be selected. For example, one of 16:9, 9:16, and 1:1 can be selected. After the aspect ratio is selected, a canvas with a corresponding size is spread, and the video is displayed in the middle of the canvas. Herein, if the size of the original video is greater than the size of the canvas, the original video needs to be equally zoomed in or out to keep the video entirely located in the canvas. Then, the size and position of the video can be adjusted, that is, it is supported to adjust the size of the video and drag and adjust the position of the video in the canvas, but it needs to be ensured that the video entirely falls within the range of the canvas and cannot be beyond the canvas. Then, conventional parameter setting is performed, for example, supporting setting of an effect, video quality, a sound effect, and a style. A setting logic employs the video generation process.

In some embodiments, for a video generation process in the canvas extension process, in response to a click/tap operation for the video generation control, coordinate information is calculated based on the video quality, the radio, and the selected region and is transmitted to a server. Then, a state of the video is determined based on data returned by the server, i.e. a queuing state and a being-generated state. The queuing state is a waiting-in-the-line state from a moment at which generation of the video is clicked/tapped to a moment at which generation starts, and a corresponding state is waiting in the line, and an estimated remaining task quantity needs to be presented on the front end. The being-generated state is a generation process from a moment at which generation starts to a moment at which a result is returned.

In some embodiments, after the queuing state and the being-generated state, a generated video returned by the server is received, and the generated video is added into the asset page. In this way, the asset page includes a newly added video generated by the interactive editing, so that an editing process of non-interactive editing may be further performed on the video, for example, the foregoing video generation process.

After the video is generated, a like operation, a dislike operation, a share operation, or a download operation may be further performed on the generated video. In addition, after generation fails, video regeneration is also supported.

A process of driving video generation by skeleton points specifically includes selecting an action template such as a dance action template, uploading an image, performing text description, and setting a parameter. First, at least one dance video template (the candidate action sequence) is displayed, to select a dance video template from the at least one dance video template. Then, a user performs an input operation, for example, uploads a local image and/or adds a text description, and then performs conventional parameter setting, for example, supporting effect setting, an aspect ratio, video quality, a sound effect, and a style. A setting logic employs the video generation process.

For a video generation process in the process of video generation driven by the skeleton points, in response to the click/tap operation for the video generation control, the dance template selected by the user and the information inputted by the user are transmitted to the server. Then, a state of the video is determined based on data returned by the server, i.e. a queuing state and a being-generated state. The queuing state is a waiting-in-the-line state from a moment at which generation of the video is clicked/tapped to a moment at which generation starts, and a corresponding state is waiting in the line, and an estimated remaining task quantity needs to be presented on the front end. The being-generated state is a generation process from a moment at which generation starts to a moment at which a result is returned.

In some embodiments, after the queuing state and the being-generated state, a generated video returned by the server is received, and the generated video is added into the asset page. In this way, the asset page includes a newly added video generated by the interactive playing method, so that editing of a non-interactive playing method may be further performed on the video, for example, the foregoing video generation process.

After the video is generated, a like operation, a dislike operation, a share operation, or a download operation may be further performed on the generated video. In addition, after generation fails, video regeneration is also supported.

In some embodiments, a video (an asset video) in an asset may be shared and downloaded. Only a video that is successfully generated can be shared, and a video that is being generated cannot be shared. Meanwhile, shared content includes a generated video, and a parameter configuration, text, and reference image information that correspond to the video.

In some embodiments, a video may be further continuously generated based on the video in the asset. A generation continue button (the regeneration control) is displayed. An editor interface (the video generation interface) is displayed after the button is clicked/tapped, and all information is filled back into an editor (the content input region) to support the user to continue editing and generation.

In some embodiments, secondary creation may be further performed based on the video in the asset. For the generated video, a regeneration button (the fifth editing control) is displayed. After the regeneration button is clicked/tapped, an editor corresponding to a long/short video is directly displayed. Corresponding text, image, and parameter configuration information is filled, so as to display, in response to the click/tap operation for the generation control, a video generated based on the filled content. In this case, the generated video is a new video, and the generated video is stored into an asset module as a new asset video, without covering original asset videos. For secondary creation of a long video, information in stages I, II, and III is filled, and stage III is directly performed.

In some embodiments, the video in the asset may alternatively be deleted, and all being-generated/completed assets support deletion. A deleted state is transmitted by the front end to the backend. If the backend determines that a deleted video is an asset that has been already synthesized/starts to be generated, data is directly deleted. If the deleted video is an asset video waiting for being generated, the request for video generation is canceled.

Next, the technical solutions of the disclosure are described from a technical side.

FIG. 28 is a schematic diagram of a structure of a video generation model according to one or more embodiments. Based on FIG. 28, the video generation model used in one or more embodiments is a model for conditional video generation based on a diffusion model. Different from a classic text-to-image diffusion model, one or more embodiments designs a three-dimensional (3D) Unet network, mainly including a main network indicated by a dashed box 2802 and a condition control network indicated by a dashed box 2801 in FIG. 28. The condition control network may encode and model various inputted reference conditions (such as a text, an image, a video, and a skeleton), and transmit encoded reference condition information to the main network to instruct the main network to learn. The main network mainly learns to predict noise at each time step, so as to subsequently perform prediction and denoising on noise data to obtain final clear video frames. In the main network and the condition control network, a time sequence modeling module is additionally added to learn motion information related to a time sequence during video generation.

In some embodiments, in a training process, video-text training data is first inputted, and training videos are combined into a B*T*C*H*W inputted video (which is set to z0), where B represents a training batch size; and T represents a quantity of frames of a generated video, and C, H, and W represent a channel, a height, and a width of a video frame. In some hidden variable-based diffusion models, C, H, and W represent a channel, a height, and a width of a hidden variable. Then, noise is inputted. Noise addition is performed on the inputted video based on a common noise addition strategy and a noise addition operation t, and the video is transmitted into a model, namely

$${z}_{t} = {α}_{t} {z}_{0} + {δ}_{t} ε \qquad Formula ( 1 )$$

where ϵ represents Gaussian noise; α and δ represent noise addition coefficients; and z₀ represents the inputted video.

Then, video spatial-temporal modeling is performed. After a noisy input zₜ enters the main network, a conv convolution in each 3D residual block and a transformer module in an Attention block perform modeling and learning on an inputted space and time sequence. Then, conditional modeling is performed. A common encoding module such as CLIP is used to extract an embedding feature of a text, and then an attention calculation is performed on a cross attention module in the Attention block and an original input to guide noise prediction of the 3D Unet. Conditional encoding is performed on image, video, and skeleton node information through a condition control module, and outputs of different 3D residual modules are conditionally controlled to be concatenated with information in the main network, to guide noise prediction of the 3D Unet. Finally, noise prediction is performed. After the noisy input zₜ and various condition information are inputted to the 3D Unet of this application, noise added in the noise addition operation tis predicted. A loss function is MSE Loss of inputted real noise. Iterative network parameters are continuously updated by minimizing the loss.

In some embodiments, after model training is completed, sampling may be performed. A sampling process is to continuously predict, from random noises by using existing condition information (a text, an image, a video, a skeleton, and the like), noises that need to be removed. Then, denoising is performed to finally generate a video. The constructed zₜ is inputted to a trained 3D Unet, and the noises are removed through multiple rounds of noise prediction, to obtain final clear and noise-free video frames. The video frames are combined at a frame rate to obtain a final video.

In some embodiments, a local video editing model in the foregoing interactive editing is a model that implements local video editing. A main structure of the local video editing model is similar to the foregoing video generation model, but inputs of the condition control module are different. Local video editing requires a user to upload a video or directly uses the generated video, and then specifies a position of a local region that needs to be edited. The local region usually refers to upper-left and lower-right coordinates of a rectangular box.

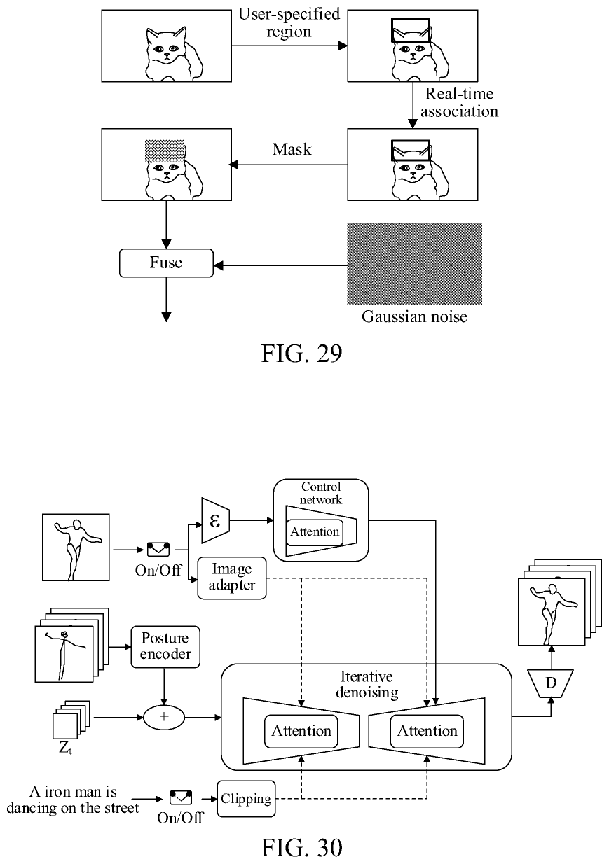

In the training and sampling processes, FIG. 29 is a schematic diagram of a sampling process according to one or more embodiments. Based on FIG. 29, a condition control and editing module may input a 0-1 binary map obtained after a region specified by a user in an original video is covered (filled with 0) and Gaussian noise to the condition control module to guide learning of a main model after connection based on channel positions. Then, for other training and sampling processes, refer to those described above.

For a skeleton-guided dance video model in the foregoing interactive editing, that is, for a process of video generation driven by skeleton points, two types of condition control modules are added into the skeleton-guided dance video model based on the video generation model. The first type is a condition control module for a skeleton sequence, and the second type is a condition control module for a given image. The skeleton sequence includes a plurality of dance skeleton templates provided by a platform, and the given image is an image including a human body and uploaded by a user.

FIG. 30 is a schematic diagram of a processing process of a skeleton-guided dance video model according to one or more embodiments. Based on FIG. 30, the skeletal guidance dance video model supports two functions. A first function is to generate a video based on a text and skeleton information. The text prompt herein is mainly a description for characters and a background of a generated video, and actions are generated based on a skeleton sequence. Condition control is performed on the skeleton information by using a lightweight convolutional network, and the text is encoded by directly using a text encoder of a general-purpose model. A second function is to generate a video based on image and skeleton information, so that an appearance of a character in the generated video is consistent with that in a given image. The image information herein is introduced through two forms: a control network and an image adapter. Then, for other training and sampling processes, refer to those described above.

In this way, one or more embodiments of the disclosure provides a relatively general-purpose video generation model controlled based on various conditions. This not only ensures that spatial and temporal motion modeling can be learned well in the video generation process (it is ensured that the image quality of the video is clear, and the motion is proper, without distortion). In addition, various condition information (a text, an image, a video, a skeleton, and the like) can be uniformly used to guide a final video generation process.

By applying one or more embodiments of the disclosure, first, the at least one video generation control configured for generating the videos of the different video types is displayed. Then, the content input region corresponding to the target video type is displayed based on the at least one video generation control in response to the target video type among the at least two video types being in the selected state, and the target content is inputted based on the content input region, thus generating the first video of the target video type based on the inputted target content. In this way, the video of the target video type that corresponds to the target content is generated based on the target content inputted by a user, so that the video content of the target video meets user requirements. Furthermore, the video of the target video type is generated based on the video generation control, so that the video type also meets the user requirements. Compared with a solution in which the user needs to clip a video to generate a final video, the disclosure enhances video generation efficiency, thereby not only enhancing human-computer interaction efficiency, but also increasing a utilization rate of hardware resources of an electronic device.

The following continues to describe an exemplary structure in which a video generation apparatus 455 provided in one or more embodiments is implemented as software modules. In some embodiments, as shown in FIG. 2, the software modules of the video generation apparatus 455 that are stored in the memory 450 may include:
a first display module 4551 configured to display at least one video generation control on a video generation interface, the at least one video generation control being configured for generating videos of at least two video types;
a second display module 4552 configured to display, based on the at least one video generation control in response to a target video type among the at least two video types being in a selected state, a content input region corresponding to the target video type;
a third display module 4553 configured to display inputted target content in response to a content input operation performed in the content input region; and
a fourth display module 4554 configured to display, in response to a video generation instruction, a first video of the target video type that is generated based on the target content.

In some embodiments, at least two video generation controls are provided. Different video generation controls correspond to different video types. The apparatus further includes: a determination module. The determination module is configured to: display, in response to an opening instruction for the video generation interface, the video generation interface including the at least two video generation controls; and in response to a video generation control, corresponding to the target video type, on the video generation interface being in a selected state, determine that the target video type is in the selected state.

In some embodiments, the apparatus further includes a parameter setting module. The parameter setting module is configured to display a parameter setting region on the video generation interface, the parameter setting region being configured for setting a parameter of the first video; and display, based on the parameter setting region in response to a parameter setting operation, a video parameter set for the first video of the target video type. The fourth display module 4554 is further configured to display, in response to the video generation instruction based on the target content, a generated first video of the target video type that has the video parameter.

In some embodiments, the target video type is a long video type. The first video of the long video type includes at least two storyboards. The apparatus further includes: a fifth display module. The fifth display module is configured to: display a storyboard breakdown interface in response to a confirmation instruction for the target content, and display, on the storyboard breakdown interface, the at least two storyboard texts determined based on the target content. Each storyboard text corresponds to one storyboard, and the storyboard texts are configured for describing corresponding storyboards. The fourth display module 4554 is further configured to display, in response to a video generation instruction triggered based on the at least two storyboard texts, a generated first video of the long video type that includes the storyboards corresponding to the storyboard texts.

In some embodiments, the apparatus further includes a sixth display module. The sixth display module is configured to: display a storyboard text quantity adjustment control, the storyboard text quantity adjustment control being configured for adding or deleting a storyboard text; display an added new storyboard text on the storyboard breakdown interface in response to a storyboard text addition operation triggered based on the storyboard text quantity adjustment control; and receive the video generation instruction in response to a confirmation operation triggered based on at least two storyboard texts including the new storyboard text.

In some embodiments, the target video type is the long video type. The first video of the long video type includes a plurality of storyboards. The apparatus further includes a seventh display module. The seventh display module is configured to: display a storyboard generation interface in response to a confirmation instruction for the target content, and display at least two storyboard texts and at least two storyboards on the storyboard generation interface, each storyboard text corresponding to one storyboard, and the storyboards being generated based on the corresponding storyboard texts. The fourth display module 4554 is further configured to display, based on the at least two storyboard texts and the at least two storyboards in response to the video generation instruction, a generated first video of the long video type that includes the at least two storyboards.

In some embodiments, the apparatus further includes a control module. The control module is configured to control the first target storyboard to be in a selected state in response to a selection operation for a first target storyboard among the at least two storyboards. The fourth display module 4554 is further configured to display, in response to the video generation instruction based on the first target storyboard that is in the selected state and the storyboard text of the first target storyboard, a generated first video of the long video type that includes the first target storyboard.

In some embodiments, the at least two storyboards have an arrangement sequence. First videos formed by the at least two storyboards in different arrangement sequences are different. An arrangement sequence adjustment control is further displayed on the storyboard generation interface. The apparatus further includes a sorting module. The sorting module is configured to change, in response to an arrangement sequence adjustment operation triggered for the at least two storyboards based on the arrangement sequence adjustment control, the arrangement sequence of the at least two storyboards from a current arrangement sequence to a target arrangement sequence. The fourth display module 4554 is further configured to display, based on the at least two storyboard texts and the at least two storyboards in response to the video generation instruction, a first video of the long video type that is generated based on the target arrangement sequence and includes the at least two storyboards.

In some embodiments, a storyboard update control configured for updating content of the storyboards is further displayed on the storyboard generation interface. The apparatus further includes a storyboard update module. The storyboard update module is configured to update, based on the storyboard update control in response to a content update operation for a second target storyboard among the at least two storyboards, the second target storyboard into a first new storyboard, content of the first new storyboard being associated with content of the second target storyboard.

In some embodiments, the at least two storyboards have an arrangement sequence. A third target storyboard among the at least two storyboards has an upward association control. The upward association control is configured for updating content of the third target storyboard based on content of a previous storyboard of the third target storyboard. The third target storyboard is any storyboard except a 1^{st} storyboard among the at least two storyboards. The apparatus further includes an upward association module. The upward association module is configured to update the third target storyboard into a second new storyboard in response to a trigger operation for the upward association control.

In some embodiments, the apparatus further includes an eighth display module. The eighth display module is configured to display function introduction information if an account performing the trigger operation generates the first video of the long video type for the first time. The function introduction information is configured for introducing a function of the upward association control.

In some embodiments, the seventh display module is further configured to: display the at least two storyboard texts on the storyboard generation interface, and display at least two candidate storyboard texts corresponding to the storyboard texts; and for each storyboard text, control the target candidate storyboard to be in a selected state in response to a selection operation for a target candidate storyboard among the at least two candidate storyboards, and determine the target candidate storyboard that is in the selected state as a storyboard corresponding to the storyboard text.

In some embodiments, the apparatus further includes a ninth display module. The ninth display module is configured to display at least one video template on the video generation interface; display, in response to a selection operation for a target video template among the at least one video template, a template content description of the target video template and a corresponding first editing control, the first editing control being configured for generating the first video of the target video type based on the template content description; and determine, in response to a trigger operation for the first editing control, the trigger operation as an input operation for the content input region. The third display module 4553 is further configured to: display the template content description of the target video template in the content input region in response to the trigger operation for the first editing control, and determine the displayed template content description as the inputted target content.

In some embodiments, the apparatus further includes a tenth display module. The tenth display module is configured to: display at least one video template on the video generation interface; display, in response to a trigger operation for a target video template among the at least one video template, a details interface including detailed information of the target video template, the details interface further including at least one of a second editing control and a first new video generation control, the second editing control being configured for generating the first video of the target video type based on the template content description, the first new video generation control being configured for re-inputting the target content to the content input region and generating the first video of the target video type based on the re-inputted target content; jumping, in response to a trigger operation for the second editing control, from the details interface to the video generation interface that includes a content input region carrying the template content description of the target video template; and jump, in response to a trigger operation for the first new video generation control, from the details interface to the video generation interface including a blank content input region. The third display module 4553 is further configured to: determine, when the trigger operation for the second editing control is received, the trigger operation as the content input operation, and determine the template content description displayed in the content input region as the inputted target content; and displaying, when the trigger operation for the first new video generation control is received, the inputted target content in response to the content input operation performed in the blank content input region.

In some embodiments, the fourth display module 4554 is further configured to display, on a video display interface in response to the video generation instruction, the first video of the target video type that is generated based on the target content. The video display interface further includes at least one of the following: detailed information of the generated first video, a third editing control, and a second new video generation control. The third editing control is configured for generating a second video of the target video type again based on the target content. The second new video generation control is configured for re-inputting the target content to the content input region and generating a third video of the target video type based on the re-inputted target content.

In some embodiments, the video display interface includes the third editing control. The target video type is the long video type. The first video of the long video type includes at least two storyboards. The apparatus further includes an eleventh display module. The eleventh display module is configured to: display a storyboard generation interface in response to a trigger operation for the third editing control; display, on the storyboard generation interface, at least two storyboard texts determined based on the target content, and display at least two storyboards determined based on the at least two storyboard texts; display at least two edited storyboard texts and at least two edited storyboards based on the storyboard generation interface in response to an editing operation for the at least two storyboard texts and the at least two storyboards; and display, in response to the video generation instruction, a second video of the long video type that is generated based on the at least two edited storyboard texts and the at least two edited storyboards.

In some embodiments, the video display interface includes the third editing control. The target video type is a short video type. The apparatus further includes a twelfth display module. The twelfth display module is configured to: display, in response to a trigger operation for the third editing control, the video generation interface including the content input region, the target content being displayed in the content input region; display, in response to an editing operation for the target content, new target content obtained by editing the target content; and display, in response to the video generation instruction, a third video of the short video type that is generated based on the new target content.

In some embodiments, the video generation interface further includes a video presentation control. The video presentation control is configured for presenting at least one asset video. The at least one asset video includes at least one of a success video of a historical generation success, a failure video of a historical generation failure, a being-generated video of a being-generated process, and a waiting video of waiting for generation. The apparatus further includes a thirteenth display module. The thirteenth display module is configured to display, in response to a trigger operation for the video presentation control, at least one asset video including the first video of the target video type.

In some embodiments, the at least one asset video includes the failure video. The failure video is associated with a regeneration control. The regeneration control is configured for regenerating the failure video. The apparatus further includes a regeneration module. The regeneration module is configured to: regenerate the target failure video in response to a trigger operation for the regeneration control associated with a target failure video among at least one failure video; switch the failure video among the at least one asset video to a regenerated fourth video when the regeneration succeeds; and display regeneration failure prompt information when the regeneration fails.

In some embodiments, the at least one asset video includes a waiting video. The apparatus further includes a fourteenth display module. The fourteenth display module is configured to: display first waiting prompt information in an associated region of the waiting video, the first waiting prompt information being configured for indicating that the corresponding waiting video is waiting for being generated; and display a waiting cancellation control in response to a trigger operation triggered for the waiting video based on the first waiting prompt information, the waiting cancellation control being configured for terminating a waiting process of the waiting video.

In some embodiments, the video generation interface further includes a style setting control. The style setting control being configured for setting a video style of the generated first video. The apparatus further includes: a style setting module. The style setting module is configured to: display at least one video style in response to a trigger operation for the style setting control; and control the target video style to be in a selected state in response to a selection operation for a target video style among the at least one video style. The fourth display module 4554 is further configured to display, in response to the video generation instruction, a first video of the target video type that is generated based on the target content and has the target video style.

In some embodiments, the style setting module is further configured to display an identifier of the target video style on the style setting control in response to a confirmation instruction for the target video style that is in the selected state, the identifier being associated with a style cancellation control, the identifier of the target video style being configured for identifying that the generated first video of the target video type has the target video style; and cancel displaying the identifier of the target video style on the style setting control in response to a trigger operation for the style cancellation control. The fourth display module 4554 is further configured to display, in response to the video generation instruction, a first video of the target video type that is generated based on the target content and has a default video style.

In some embodiments, the fourth display module 4554 is further configured to display second waiting prompt information in response to the video generation instruction, the second waiting prompt information being configured for indicating waiting duration to beginning of generation of the first video; cancel displaying the second waiting prompt information when the second waiting prompt information indicates that the waiting duration to the beginning of the generation of the first video is zero; and display the first video of the target video type that is generated based on the target content.

In some embodiments, the apparatus further includes an interaction module. The interaction module is configured to: display at least one interaction control for the first video, the interaction control being one of the following controls: a local editing control configured for locally editing the first video, a canvas extension control configured for editing a size of the first video, a moving brush control configured for turning a static object in the first video into a dynamic object, a camera movement parameter setting control configured for setting a camera movement parameter of the first video, a background removal control configured for removing a background of the first video, an object erase control configured for erasing a target object from the first video, a scene detection control configured for segmenting the video into different video clips based on different scenes in the first video, a depth-of-field control configured for setting a depth-of-field effect for the first video, a frame rate adjustment control configured for adjusting a frame rate of a storyboard in the first video, an action sequence generation control configured for setting an action sequence for an object in the first video, and a third new video generation control configured for generating a new video based on audio data in the first video; and perform, in response to a trigger operation for a target interaction control among the at least one interaction control, an interaction operation indicated by the target interaction control on the first video of the target video type.

One or more embodiments provides a computer program product. The computer program product includes a computer-executable instruction, and the computer-executable instruction is stored in a computer-readable storage medium. A processor of an electronic device reads the computer-executable instruction from the computer-readable storage medium, and the processor executes the computer-executable instruction, to cause the electronic device to perform the foregoing video generation method according to one or more embodiments.

One or more embodiments provides a computer-readable storage medium, having a computer-executable instruction stored therein. When the computer-executable instruction is executed by a processor, the processor is caused to perform the foregoing video generation method according to one or more embodiments, for example, the video generation method shown in FIG. 3.

In some embodiments, the computer-readable storage medium may be a memory such as a read-only memory (ROM), a random access memory (RAM), an erasable programmable read-only memory (EPROM), an electrically erasable programmable read-only memory (EEPROM), a flash memory, a magnetic surface memory, an optical disc, or a compact disc-ROM (CD-ROM), or may be various devices including one of the foregoing memories or any combination thereof.

In some embodiments, the computer-executable instructions may be written in the form of program, software, software module, script, or code in any form of programming language (including compilation or interpretation language, or declarative or procedural language), and the computer executable instructions may be deployed in any form, including being deployed as an independent program or being deployed as a module, component, subroutine, or another unit suitable for use in a computing environment.

In an example, the computer-executable instructions may but do not necessarily correspond to a file in a file system, and may be stored as a part of a file that saves other programs or data, for example, stored in one or more scripts in a Hypertext Markup Language (HTML) document, stored in a single file dedicated to a discussed program, or stored in a plurality of collaborative files (for example, files that store one or more modules, subprograms, or code parts).

In an example, the computer-executable instructions may be deployed to be executed on one electronic device, on a plurality of electronic devices located at one site, or on a plurality of electronic devices distributed at a plurality of locations and connected by a communication network.

In summary, one or more embodiments of the disclosure has the following beneficial effects:
(1) The video of the target video type that corresponds to the target content is generated based on the target content inputted by a user, so that the video content of the target video meets user requirements. Furthermore, the video of the target video type is generated based on the video generation control, so that the video type also meets the user requirements. Compared with a solution in which the user needs to clip a video to generate a final video, the disclosure reduces a clip operation needing to be performed by a user on a video, thereby not only enhancing video generation efficiency, but also enhancing human-computer interaction efficiency and increasing a utilization rate of hardware resources of an electronic device.
(2) This not only ensures that spatial and temporal motion modeling can be learned well in the video generation process (it is ensured that the image quality of the video is clear, and the motion is proper, without distortion). In addition, various condition information (a text, an image, a video, a skeleton, and the like) can be uniformly used to guide a final video generation process.
(3) Content and effect correlation between storyboards is enhanced based on the upward association control.

In the embodiments, relevant data such as operation data of a user and target content inputted by a user is involved. When one or more embodiments are applied to specific products or technologies, a permission or consent of a user is required, and acquisition, use, and processing of the related data need to comply with relevant laws, regulations, and standards of relevant countries and regions.

The foregoing embodiments are used for describing, instead of limiting the technical solutions of the disclosure. A person of ordinary skill in the art shall understand that although the disclosure has been described in detail with reference to the foregoing embodiments, modifications can be made to the technical solutions described in the foregoing embodiments, or equivalent replacements can be made to some technical features in the technical solutions, provided that such modifications or replacements do not cause the essence of corresponding technical solutions to depart from the spirit and scope of the technical solutions of the embodiments of the disclosure and the appended claims.

What is claimed is:

1. A video generation method, performed by an electronic device, comprising:
displaying at least one video generation control on a video generation interface, the at least one video generation control being configured for generating videos of at least two video types;
displaying, based on the at least one video generation control associated with a target video type among the at least two video types being in a selected state, a content input region corresponding to the target video type;
displaying inputted target content based on a content input operation being performed in the content input region; and
displaying, based on a video generation instruction, a first video of the target video type that is generated based on the inputted target content.

2. The video generation method according to claim 1, wherein the at least one video generation control comprises at least two video generation controls where different video generation controls correspond to different video types, and the displaying the at least one video generation control on the video generation interface comprises:
displaying, based on an opening instruction for the video generation interface, the video generation interface comprising the at least two video generation controls; and
wherein before the displaying, based on the target video type among the at least two video types being in the selected state, the content input region corresponding to the target video type, the video generation method further comprises:
determining that the target video type is in the selected state based on a video generation control on the video generation interface that corresponds to the target video type being in the selected state.

3. The video generation method according to claim 1, further comprising:
displaying a parameter setting region on the video generation interface, the parameter setting region being configured for setting a parameter of the first video; and
displaying, based on a parameter setting operation, a video parameter set for the first video of the target video type; and
wherein the displaying the first video of the target video type that is generated based on the inputted target content comprises:
displaying, based on the video generation instruction, a generated first video of the target video type that has the video parameter based on the inputted target content.

4. The video generation method according to claim 1, wherein the target video type is a long video type and the first video of the long video type comprises at least two storyboards; and
wherein after the displaying inputted target content based on the content input operation performed in the content input region, the video generation method further comprises:
displaying a storyboard breakdown interface based on a confirmation instruction for the inputted target content, and displaying, on the storyboard breakdown interface, at least two storyboard texts determined based on the inputted target content;
wherein each storyboard text corresponds to one storyboard, and each storyboard text is configured for describing the corresponding storyboard; and
wherein the displaying the first video of the target video type that is generated based on the inputted target content comprises:
displaying, based on the video generation instruction triggered based on the at least two storyboard texts, a generated first video of the long video type that comprises the corresponding storyboards.

5. The video generation method according to claim 4, further comprising:
displaying a storyboard text quantity adjustment control, the storyboard text quantity adjustment control being configured for adjusting a quantity of the storyboard texts;
displaying an added new storyboard text on the storyboard breakdown interface based on a storyboard text addition operation associated with the storyboard text quantity adjustment control; and
receiving the video generation instruction based on a confirmation operation triggered based on at least two storyboard texts comprising the new storyboard text.

6. The video generation method according to claim 1, wherein the target video type is the long video type; the first video of the long video type comprises a plurality of storyboards;
wherein after the displaying inputted target content based on the content input operation performed in the content input region, the video generation method further comprises:
displaying a storyboard generation interface based on a confirmation instruction for the inputted target content, and displaying at least two storyboard texts and at least two storyboards on the storyboard generation interface, each storyboard text corresponding to one storyboard, and each storyboard being generated based on the corresponding storyboard text; and
wherein the displaying the first video of the target video type that is generated based on the inputted target content comprises:
displaying, based on the video generation instruction, a generated first video of the long video type that comprises the at least two storyboards based on the at least two storyboard texts and the at least two storyboards.

7. The video generation method according to claim 6, wherein after the displaying the at least two storyboard texts and the at least two storyboards on the storyboard generation interface, the video generation method further comprises:
controlling a first target storyboard to be in the selected state based on a selection operation for the first target storyboard among the at least two storyboards; and
wherein the displaying the generated first video of the long video type that comprises the at least two storyboards comprises:
displaying, based on the video generation instruction, the generated first video of the long video type that comprises the first target storyboard based on the first target storyboard that is in the selected state and the storyboard text of the first target storyboard.

8. The video generation method according to claim 6, wherein the at least two storyboards have an arrangement sequence, first videos formed by the at least two storyboards in different arrangement sequences are different;
wherein the video generation method further comprising displaying an arrangement sequence adjustment control on the storyboard generation interface;
wherein after the displaying the at least two storyboard texts and the at least two storyboards on the storyboard generation interface, the video generation method further comprises:
changing, based on an arrangement sequence adjustment operation on the arrangement sequence adjustment control, the arrangement sequence of the at least two storyboards from a current arrangement sequence to a target arrangement sequence; and
wherein the displaying the generated first video of the long video type that comprises the at least two storyboards comprises:
displaying, based on the video generation instruction, a first video of the long video type that is generated based on the target arrangement sequence and comprises the at least two storyboards based on the at least two storyboard texts and the at least two storyboards.

9. The video generation method according to claim 6, further comprising:
displaying a storyboard update control configured for updating content of the storyboards on the storyboard generation interface; and
after the displaying the at least two storyboard texts and the at least two storyboards on the storyboard generation interface, updating, based on a content update operation for a second target storyboard among the at least two storyboards on the storyboard update control, the second target storyboard into a first new storyboard, content of the first new storyboard being associated with content of the second target storyboard.

10. The video generation method according to claim 6, wherein the at least two storyboards have an arrangement sequence; a third target storyboard among the at least two storyboards has an upward association control; the upward association control is configured for updating content of the third target storyboard based on content of a previous storyboard of the third target storyboard; the third target storyboard is any storyboard except a first storyboard among the at least two storyboards; and
wherein after the displaying the at least two storyboard texts and the at least two storyboards on the storyboard generation interface, the video generation method further comprises:
updating the third target storyboard into a second new storyboard based on a trigger operation for the upward association control.

11. The video generation method according to claim 10, wherein before the updating the third target storyboard the a second new storyboard, the video generation method further comprises:
displaying function introduction information based on an account performing the trigger operation generating the first video of the long video type for a first time; and
wherein the function introduction information is configured for introducing a function of the upward association control.

12. The video generation method according to claim 6, wherein after the displaying the at least two storyboard texts and the at least two storyboards on the storyboard generation interface, the video generation method further comprises:
displaying the at least two storyboard texts on the storyboard generation interface, and displaying at least two candidate storyboard texts corresponding to the storyboard texts; and
for each storyboard text, controlling the target candidate storyboard to be in the selected state based on a selection operation for a target candidate storyboard among the at least two candidate storyboards, and determining the target candidate storyboard that is in the selected state as a storyboard corresponding to the storyboard text.

13. The video generation method according to claim 1, further comprising:
displaying at least one video template on the video generation interface;
displaying, based on a selection operation for a target video template among the at least one video template, a template content description of the target video template and a corresponding first editing control, the first editing control being configured for generating the first video of the target video type based on the template content description; and
determining, based on a trigger operation for the first editing control, the trigger operation as an input operation for the content input region, wherein
the displaying the inputted target content based on the content input operation performed in the content input region comprises:
displaying the template content description of the target video template in the content input region based on the trigger operation for the first editing control, and determining the displayed template content description as the inputted target content.

14. The video generation method according to claim 1, further comprising:
displaying at least one video template on the video generation interface;
displaying, based on a first trigger operation for a target video template among the at least one video template, a details interface comprising detailed information of the target video template, the details interface further comprising at least one of a second editing control and a first new video generation control, the second editing control being configured for generating the first video of the target video type based on the template content description, the first new video generation control being configured for re-inputting the target content to the content input region and generating the first video of the target video type based on the re-inputted target content;
jumping, based on a second trigger operation for the second editing control, from the details interface to the video generation interface that comprises the content input region carrying the template content description of the target video template; and
jumping, based on a third trigger operation for the first new video generation control, from the details interface to the video generation interface comprising a blank content input region, wherein
the displaying the inputted target content based on the content input operation performed in the content input region comprises:
determining, based on the second trigger operation for the second editing control being received, the second trigger operation as the content input operation, and determining the template content description displayed in the content input region as the inputted target content; and
displaying, based on the third trigger operation for the first new video generation control being received, the inputted target content based on the content input operation performed in the blank content input region.

15. The video generation method according to claim 1, wherein the displaying the first video of the target video type that is generated based on the inputted target content comprises:
displaying, on a video display interface based on the video generation instruction, the first video of the target video type that is generated based on the inputted target content;
wherein the video display interface further comprises at least one of detailed information of the generated first video, a third editing control, and a second new video generation control; and
wherein the third editing control is configured for generating a second video of the target video type again based on the inputted target content; and the second new video generation control is configured for re-inputting the inputted target content to the content input region and generating a third video of the target video type based on the re-inputted target content.

16. The video generation method according to claim 1, wherein the video generation interface further comprises a video presentation control; the video presentation control is configured for presenting at least one asset video; the at least one asset video comprises at least one of a success video of a historical generation success, a failure video of a historical generation failure, a being-generated video of a being-generated process, and a waiting video of waiting for generation; and
wherein after the displaying the first video of the target video type that is generated based on the inputted target content, the video generation method further comprises:
displaying, based on a trigger operation for the video presentation control, at least one asset video comprising the first video of the target video type.

17. The video generation method according to claim 1, wherein the video generation interface further comprises a style setting control; the style setting control being configured for setting a video style of the generated first video; and
wherein after the displaying the at least one video generation control on the video generation interface, the video generation method further comprises:
displaying at least one video style based on a trigger operation for the style setting control; and
controlling a target video style to be in the selected state based on a selection operation for the target video style among the at least one video style; and
wherein the displaying the first video of the target video type that is generated based on the inputted target content comprises:
displaying, based on the video generation instruction, the first video of the target video type that is generated based on the inputted target content and has the target video style.

18. The video generation method according to claim 1, wherein after the displaying the first video of the target video type that is generated based on the inputted target content, the video generation method further comprises:
displaying at least one interaction control for the first video, the at least one interaction control being at least one of: a local editing control configured for locally editing the first video, a canvas extension control configured for editing a size of the first video, a moving brush control configured for turning a static object in the first video into a dynamic object, a camera movement parameter setting control configured for setting a camera movement parameter of the first video, a background removal control configured for removing a background of the first video, an object erase control configured for erasing a target object from the first video, a scene detection control configured for segmenting the video into different video clips based on different scenes in the first video, a depth-of-field control configured for setting a depth-of-field effect for the first video, a frame rate adjustment control configured for adjusting a frame rate of a storyboard in the first video, an action sequence generation control configured for setting an action sequence for an object in the first video, and a third new video generation control configured for generating a new video based on audio data in the first video; and
performing, based on a trigger operation for a target interaction control among the at least one interaction control, an interaction operation indicated by the target interaction control on the first video of the target video type.

19. A video generation apparatus, the apparatus comprising:
at least one memory configured to store program code; and
at least one processor configured to read the program code and operate as instructed by the program code, the program code comprising:
first display code configured to cause at least one of the at least one processor to display at least one video generation control on a video generation interface, the at least one video generation control being configured for generating videos of at least two video types;
second display code configured to cause at least one of the at least one processor to display, based on the at least one video generation control associated with a target video type among the at least two video types being in a selected state, a content input region corresponding to the target video type;
third display code configured to cause at least one of the at least one processor to display inputted target content based on a content input operation performed in the content input region; and
fourth display code configured to cause at least one of the at least one processor to display, based on a video generation instruction, a first video of the target video type that is generated based on the inputted target content.

20. A non-transitory computer-readable storage medium, storing computer code which, when executed by at least one processor, causes the at least one processor to at least:
display at least one video generation control on a video generation interface, the at least one video generation control being configured for generating videos of at least two video types;
display, based on the at least one video generation control associated with a target video type among the at least two video types being in a selected state, a content input region corresponding to the target video type;
display inputted target content based on a content input operation being performed in the content input region; and
display, based on a video generation instruction, a first video of the target video type that is generated based on the inputted target content.
